(19) United States
(12) Patent Application Publication
(10) Pub. No.: US 2012/0106733 A1
(43) Pub. Date: May 3, 2012

(54) SYSTEM AND METHOD FOR DATA ENCRYPTION

(76) Inventors: Janet M. Falch, Tinley Park, IL (US); Willie Bablinski, Denver, CO (US)

(21) Appl. No.: 12/938,908

(22) Filed: Nov. 3, 2010

(51) Int. Cl. H04L 9/28

(52) U.S. Cl. 380/46

(57) ABSTRACT

A computer executable encryption/decryption system implementing a provably unbreakable cyphering technique having a repeat period of at least a googol with every computer/detachable device having its own unique provably unbreakable encryption. The system comprises an encryption processor, a Googol Production Engine module comprising a plurality of virtual wheels, a digital curtain module comprising a symbol encryption table, a decider module for selecting one of the input data element and the inert ingredient for encryption via the digital curtain, a column selector (Driveshaft) module for advancing the columns in the digital curtain module with a repeat of over a googol for encryption output, and a communications interface operatively connected to computer readable memory and the encryption processor. In an embodiment, the most recent encryption location becomes a new starting coordinate for the next encryption. With precision and controlled variables, the encryption process changes both with and within each encryption.

### FIELD

This invention is generally related to the field of secure transmission of electronic data and more particularly to computer implemented data encryption and decryption algorithms.

### BACKGROUND OF THE INVENTION

Message encryption and decryption allows transmission of information between communication endpoints in a private manner, so as to exclude unintended eavesdropping. Various information ciphering techniques exist that attempt to meet the needs of private information transmission.

Messages may be ciphered by a predetermined substitution of characters. A letter, a number, or any other symbol may be substituted with another letter, number, or symbol in a predetermined manner prior to message transmission. The message recipient then decrypts the incoming message by applying a cipherment key by which the substitutions were made. Such techniques vary in their complexity and strength.

One example of a cipherment apparatus is an Enigma machine that has been in existence since at least World War II. The Enigma machine employed electro-mechanical rotors, where each rotor performed a substitution cipher. The Enigma machine's various cryptographic weaknesses included a reliance on a global starting position for the rotors, a limited number of rotor position combinations, physical size limitations and slow decryption speed, among others. While computer implemented digital replicas of Enigma machines have been made, they merely replicate the same cryptographic limitations in digital form and, therefore, also do not possess the adequate coding strength needed to prevent the eavesdropping of digital transmissions.

### BRIEF SUMMARY OF THE INVENTION

Embodiments of the invention are used to provide a computer executable encryption/decryption process resulting in a provably unbreakable ciphering technique having a repeat period of at least a googol (e.g., on the order of 1.03042931899423×10¹⁰⁰) and designed to provide a unique code for every computer/detachable device with all communication decrypted then re-encrypted to the encryption found on the end user's computer.

In one aspect of the invention, an electronic data encryption system is provided comprising (a) an encryption processor, (b) a computer readable memory operatively connected to the encryption processor, the computer readable memory receiving an input of a data element for encryption and having stored thereon a plurality of modules comprising computer executable instructions executed by the encryption processor, the modules comprising (i) a Googol Production Engine comprising a plurality of virtual wheels, each virtual wheel comprising a queue of a plurality of random single digit numbers, the virtual wheel configured for selecting a single digit selected from the plurality of random single digit numbers in a continuous circular order such that as a last digit in the queue is selected the first digit is queued up for a subsequent selection, wherein each virtual wheel in the plurality of virtual wheels comprises at least a predetermined number of single digit numbers, each virtual wheel in the plurality of virtual wheels having a different amount of single digit numbers than the other virtual wheels, (ii) a digital curtain module comprising a symbol encryption table wherein each column and row intersection corresponds to a numerical coordinate, the numerical coordinate corresponding to each column and row intersection having a single entry comprising one of the received input data element and an inert ingredient, the inert ingredient comprising a predetermined filler encryption element, a Ground Zero mode within the digital curtain module which changes the numerical coordinate of the last selection to (000, 000) thus constantly shifting the digital curtain module, (iii) a decider module for selecting one of the input data element and the inert ingredient for encryption via the digital curtain, the decider module making said selection based on a sum of the single digits selected by each of the plurality of virtual wheels, (iv) a Driveshaft (column selector) module for advancing and selecting a column in the digital curtain module for encryption output, the column selector module (Driveshaft) identifying each digit of the numerical coordinate of the column in the digital curtain by computing a last digit of a sum of the digits selected by a respective subset of the virtual wheels, the encryption output comprising the numerical coordinate of the column and row intersection corresponding to one of the input data element and the inert ingredient selected for encryption, and (c) a communications interface operatively connected to the computer readable memory and the encryption processor for transmitting the encryption output to a remote computing device.

Embodiments of the invention further comprise a Central Code Administrator (CCA) and Self Activating Virus (SAV). The Central Code Administrator decrypts an incoming message, holds it until the intended end user logs onto the CCA, and then re-encrypts the message to the end user's coding configuration (on a computer or detachable device). The Self Activating Virus (SAV) destroys the contents of the computer should either: 1) the CCA becomes aware that the computer is no longer secure and gives the command to deploy the SAV, or 2) a predetermined number of failed login attempts have been reached automatically causing the deployment of the SAV.

### BRIEF DESCRIPTION OF THE DRAWING(S)

While the appended claims set forth the features of the present invention with particularity, the invention and its advantages are best understood from the following detailed description taken in conjunction with the accompanying drawings, of which:

FIG. 1-A is a schematic diagram illustrating an embodiment of the Webcloak cypherment technique with reference to a computer system comprising a plurality of communicatively connected computing devices;

FIG. 1-B is a schematic diagram illustrating an embodiment of hardware components for implementing the computing devices of the cypherment system of FIG. 1-A;

FIGS. 2-A-3B are schematic diagrams illustrating an encryption/decryption process of the Webcloak cypherment technique in accordance with an embodiment of the invention;

FIGS. 4 and 6 are schematic diagrams illustrating an embodiment of a Googol Production Engine (GPE) used for the production of numbers which in turn are used in the processing of an encryption. FIG. 6 depicts an embodiment of an allocation of the value of Window Boxes via a Driveshaft Subcomponent (DS) Assignment Number of the Webcloak cypherment technique in accordance with an embodiment of the invention;

FIGS. 5-A, 5-B are schematic diagrams illustrating a small segment of Virtual Wheel 100 and the various parts within said Virtual Wheel in accordance with an embodiment of the invention;

FIGS. 7-A through 7-D are schematic diagrams illustrating a Digital Curtain module of the Webcloak cypherment system in accordance with an embodiment of the invention;

FIG. 8 is a schematic diagram illustrating an embodiment of an allocation of the value of Window Boxes via a Driveshaft Subcomponent (DS) Assignment Number of the Webcloak cypherment technique in accordance with an embodiment of the invention;

FIG. 9 is a schematic diagram illustrating identification of a subset of Virtual Wheels in accordance with an embodiment of the invention;

FIG. 10 is a schematic diagram illustrating an embodiment of countboxes used in the encryption process;

FIG. 11 is a schematic diagram illustrating the encryption and decryption process in accordance with an embodiment of the invention;

FIGS. 12-A through 12-E are schematic diagrams illustrating an embodiment of an encryption process of the Webcloak cypherment technique in accordance with an embodiment of the invention;

FIGS. 13-A through 13-E are schematic diagrams illustrating an embodiment of a decryption process of the Webcloak cypherment technique in accordance with an embodiment of the invention;

FIGS. 14-A through 14-D are schematic diagrams illustrating another embodiment of the Digital Curtain module of the Webcloak cypherment system as it relates to the hypothetical encryption example provided within FIGS. 12-A through 12-E and 13-A through 13-E;

FIGS. 15-A through 15-B are schematic diagrams illustrating an embodiment of a process performed by the Central Code Administrator in facilitating the encryption and decryption of end user messages and message management in accordance with an embodiment of the invention;

FIGS. 16-A through 16-B are schematic diagrams illustrating an exemplary recipe employed by the Webcloak cypherment technique in accordance with an embodiment of the invention;

FIG. 17 is a schematic diagram illustrating a computer implemented cypherment system including a Central Code Administrator and Self Activating Virus in accordance with an embodiment of the invention;

FIG. 18 is a schematic diagram illustrating an exemplary calculation of a repeat of a hypothetical Googol Production Engine in accordance with an embodiment of the invention;

FIG. 19 is a schematic diagram illustrating an embodiment of a larger GPE (Googol Production Engine Extra Large) used for the production of numbers which in turn are used in the processing of an encryption in accordance with an embodiment of the invention;

FIG. 20 is a schematic diagram illustrating the use of multiple of Digital Curtain modules of the Webcloak cypherment system in accordance with an embodiment of the invention; and

FIGS. 21-A through 21-F are tables of reference numbers and corresponding elements employed in the foregoing FIGS. 1-A through 20 in accordance with the corresponding embodiments of the invention.

### DETAILED DESCRIPTION OF THE INVENTION

Embodiments of the invention provide a computer implemented encryption/decryption process resulting in a provably unbreakable cyphering technique having a repeat period of at least a googol (e.g., on the order of 1.03042931899423×10¹⁰⁰). The coding approach described herein is generally referred to as the “Webcloak.”

System Overview

The Webcloak is an encryption/decryption process that is provably unbreakable due to the use of 1) inert ingredients (fillers), 2) having a repeat period of a googol, 3) a key in which the probability of any given 3-digit encryption is equally likely to be any of the 1,000 (or less) available selections (letters, numbers, symbols, space, ii, character) and 4) the creation of a unique encryption for every computer/portable device. Both the use of inert ingredients/fillers in the encryption and the ability to provide a googol repeat period are each independently capable of creating a provably unbreakable code, but together they further enhance the strength of encryption.

One part of the process described herein comprises an extensive use of inert ingredients (ii) which fill an overall average of 50% of the encryptions. The other part involves the use of a Digital Curtain (DC) encryption lookup table, which ensures that any 3 digit number is equally represented by one letter/number/symbol/ii vs. another letter/number/symbol/ii/character. Both The Decider and DC are powered by a Googol Production Engine. Each part is described in further detail below.

Googol Production Engine—The Googol Production Engine (GPE) is the engine that powers both the selection (or non-selection) of the inert ingredients via The Decider with its odd/even results and the 3-digit numeric advancement of the Digital Curtain via “The Driveshaft”, both of which are described in further detail below.

In one embodiment, the GPE includes twenty five (25) virtual wheels (VW). Each VW contains a minimum of 10,000 random single digit numbers from 0-9 of equal (within one) quantity and “strung” together one digit at a time in a virtual continuous circle. In an embodiment, each virtual wheel comprises one or more shift registers that implement a circular queue and are operatively connected to an encryption processor and, optionally, a memory controller. In an alternate embodiment, thirty (30) virtual wheels are employed by the Googol Production Engine to further enhance the strength of encryption resulting in a repeat of approximately (1.04441538425145×10¹²⁰). Since each computer contains its own unique Webcloak and Googol Production Engine, one compromised computer does not compromise the entire encryption process.

As the last digit is used, the first digit is the next one to be displayed (the digits “wrap” in a continuous circle). No two virtual wheels contain the same number of total digits 0-9 linked in random order. Each VW has a “window box”, an output box, which outputs one digit at a time. The sum of the digits displayed by all VWs determines the use of inert ingredients (ii) vs. “active” entries (originating from the original message) of the cypherment by its odd/even results. The Driveshaft, described in further detail below, uses various parts of the GPE to create a 3-digit code to advance the columns in the Digital Curtain (DC) and a selection of one column from which the cypherment will be made. Each VW moves one digit at a time around as a circle, time and time again always in the same direction, and in the same order. Since each VW contains a different amount of digits with a minimum of 10,000 digits each, the repeat of 25 VWs is a minimum of a googol (the googol is calculated by multiplying each total number of digits in each VW by all 25 VWs totals).

In an embodiment, each successive virtual wheel contains one additional number of single digits as compared to its immediate VW neighbor. Each VW contains a single Encryption Marker and a single Decryption Marker. The Encryption Marker and Decryption Marker are designed to ensure that the encryption and decryption process on both computer/detachable device #1 and computer/detachable device #2 (or the CCA in lieu of computer/detachable device #2) are continually synced with each other by ensuring that the window boxes on each VW are properly aligned. The initial location of the encryption markers on computer/detachable device #1 matches the location of the decryption markers on computer/detachable device #2. The decryption markers on computer/detachable device #1 match the location of the encryption markers on computer #2. When an encrypted message is sent, a special coding is sent to note how many advancements (“ticks”) the VWs have advanced since the inception of the Webcloak.

“The Decider” is calculated by the addition of all VW's Window boxes upon a single advancement of the Googol Production Engine. If the results are an odd number, then the next digit to be ciphered is “active” (e.g., a letter/number/symbol/space character will be encrypted). If the cumulative results are an even number, then the next digit to be ciphered is an inert ingredient (ii). In one embodiment, a contingency has been added to ensure that the odd/even results used in the selection of an ii or “active” encryption do not create any pattern.

In an embodiment, the Googol Production Engine (GPE) includes the following computer executable instructions:
a. To begin, the encryption markers for all virtual wheels (VW) are aligned along their corresponding window box which in turn aligns the VWs to the last placement the VWs ended at the last encryption. If this were a decryption, the VWs would adjust their alignment along the window boxes to the placement of their decryption markers. The received encrypted message would contain within the number of advancements (“ticks”) the GPE has made since the inception of the GPE to ensure all VWs are properly aligned.
b. All VWs turn to the next digit (turns one digit at a time in the same direction).
c. The one display/output window box per VW shows the single digit number for each VW (0-9 of equal quantity (within one) in random order).
d. To calculate “The Decider”, all twenty five (25) displayed numbers are added together. If the number is even, the VW chooses the next cipher in the Digital Curtain (DC) to be ii, if odd, the next letter/number/symbol/space character from the original message will be chosen from the DC.
e. The same numeric values from the above 25 window boxes are used to calculate the 3 digits that comprise of the Driveshaft. The value of the first 10 (1-10) window boxes is added together and the last digit of the sum is the first digit used for The Driveshaft. Window boxes 9-18 (10 total) are added together and the last digit is used to represent the second digit of the Driveshaft number. Window Box numbers 17-25 and Window Box number 1(10 total) are added together for the third digit of the Driveshaft number. Each of the 3 digits has a near-equal probability of being any number between 0-9 with a slight favoring of the number “5” and the numbers just before and after it. The 3 digit Driveshaft number is used to advance the Digital Curtain lookup table from the last place it landed (Ground Zero, coordinates 000,000).
f. Either ii or the next number/letter/symbol/space character is chosen from the column in the Digital Curtain chosen by the 3-digit Driveshaft number. A downward count of rows is done until the matching number/letter/symbol/space/ii is found. That number becomes a 3-digit number and is transferred as a 3-digit number to the Encryption Box.
g. Repeat until all digits are deciphered. Contingencies may dictate if and when additional ii are to be added to the encryption.

Upon completion, Encryption Markers mark the exact location each Window Box fell upon its corresponding VW. The total numeric advancement since the inception of the Webcloak is encoded into the encryption. Thus, emails written in different times are able to be opened in non-sequential order.

The encryption is sent to the server, Central Code Administrator (CCA), where the exact Webcloak configuration from the sender's computer is duplicated including the initial encryption marker location. The message is deciphered and held by the CCA until the intended end user logs onto the CCA. When the intended end user logs onto the CCA, the message is re-ciphered to the intended party's Webcloak configuration.

Contingencies—Contingencies exist to ensure that encryption falls within an acceptable range of outcomes ensuring that no patterns form and that the inevitable continuous outcome of the same results does not hinder the encryption process. A range of acceptable values for each contingency is created upon the creation of the Webcloak. The values of the various ranges are then established at the inception of a new encryption and with the outcome of the first turn/“tick” of the Googol Production Engine (GPE). Contingencies are 1) created to disguise small messages and are based on the size of the message to be encrypted 2) created to ensure that a continuous odd/even selection does not hinder the overall encryption size (which is tentatively set to contain between 20-80% inert ingredients (ii) for larger messages) and 3) created to ensure that the selection of columns within the digital curtain are not continuously aligned with the odd/even outcome of The Decider. With a repeat of a googol, the probability that the same outcome will repeat itself beyond a reasonable and acceptable limit is inevitable. Tentatively the acceptable limit is set at no more than an 80% usage of either the ii or data element (character from the original message to be encrypted).

In an embodiment, the GPE employs one or more of the following contingencies represented within their own countboxes:

1) If the total number of Encrypted Digits (number of characters to be encrypted) is ≦100, than additional ii are to be added to the beginning and end of the encryption. The number of ii is determined by a prearranged formula. An example of one such formula for the value of the ii to be entered at the beginning of the encryption is numeric value of Driveshaft #1+3, with a value range of 3-12. An example of one such formula for the value of the ii to be entered at the end of an encryption is numeric value of Driveshaft #3+3, with a value range of 3-12. The default value of the ii Start Count box is two (2) and the default value of the ii End Countbox is one (1).

2) A tally noting the continuous use of an ii selection and an element selection is made in their corresponding countboxes. When a predetermined number of continuous selections is made (such as 4, which, if “The Decider” continues to make the same repeated odd/even selection, the encryption would result in approximately a 20/80 split between ii/elements or elements/ii without regard to other contingencies), the system automatically chooses the “other” selection in spite of the results of “The Decider” and the countboxes of that item cleared with one count added to the other selection. Thus, if 4 ii were selected, the system would select a message element in spite of the results of “The Decider”. The system would clear the count of the ii and add one count to the element countbox.

3) A tally of the running total of all ciphered items is made. When the cumulative count of all continuous ii and elements reach the maximum number allowed, an automatic selection of an ii is used in spite of the ii countbox results and “The Decider” results. The Encryption Countbox is cleared of its value. Preferably, a count to the ii countbox is not added in.

The decipherment process of a received encrypted message does not have any countboxes or “The Decider”. The decryption uses the Driveshaft (3 digit number created from the GPE described below) to select a column from the Digital Curtain and the 3-digit encryption code to select the row from which the letter/number/space/symbol/ii/character will be selected.
1. All virtual wheels (VW) turn to the next digit (turns one digit at a time in the same direction).
   a. The one display/output window box per VW shows the single digit (0-9 of equal quantity (within one) in random order) number for each VW.
   b. After the turn, the 3 digit Driveshaft is calculated and displayed. The 3-digit Driveshaft is derived from the 25 VWs window boxes. The first 10 (1-10) VWs window boxes are added together and the last digit is the first digit used for The Driveshaft code. Window boxes for VW numbers 9-18 are added together and the last digit is used to represent the second digit of The Driveshaft number. Window boxes VW numbers 17-25 and window box VW number 1 are added together for the third digit of the Driveshaft number. This 3 digit number has a near equal probability of being any number between 000-999. Use the value of the Driveshaft to advance the columns within the Digital Curtain lookup table from Ground Zero (000,000), (the location of the prior encryption).
   c. From the column selected by the Driveshaft, a downward count of rows is processed using the first 3-digits from the Encrypted Message Received. If the corresponding value is an ii, no value is transferred to the Decryption Box and the steps are repeated until all digits are deciphered. If the corresponding digit is a number/letter/symbol/space character, then said digit is transferred to the Decryption Box.
   d. Repeat until all digits are deciphered.

Upon completion, Decryption Markers mark the exact location each Window Box fell upon its corresponding VW.

The total numeric advancement since the inception of the Webcloak is encoded into the encryption. Thus, emails written in different times are able to be opened in non-sequential order.

The encryption is sent to the server, Central Code Administrator (CCA), where the exact Webcloak configuration from the sender's computer is duplicated including the initial encryption marker location. The message is deciphered and held by the CCA until the intended end user logs onto the CCA. When the intended end user logs onto the CCA, the message is re-ciphered to the intended party's Webcloak configuration.

The Driveshaft—The Driveshaft is a 3 digit number that changes with each cypherment and is used to power the advancement and ultimately the selection of the next cypherment column from the Digital Curtain. The Driveshaft advances from its most recent position, Ground Zero, which becomes the new starting point within the Digital Curtain. Thus, the column selection in the Digital Curtain encoding table rotates around, left to right, top to bottom in a continuous circle. Each digit of The Driveshaft is the last digit in the sum of 10 predetermined VWs Window Boxes. There is a near equal probability of an occurrence from 000-999 with a slight favoring of the number “5” and “0” as the least occurring value. In an embodiment with twenty five (25) VWs Window Boxes, five of the VWs Window Boxes (e.g., outputs) are used in two of the formulas that determine a single digit of The Driveshaft. To encrypt a character, the columns within the Digital Curtain lookup table advance from Ground Zero (the most recent column selection from the last cypherment with coordinates (000, 000)) to the right by the 3-digit driveshaft number. The selected column is the column from which the item to be encrypted is selected. Within said column, the item to be encrypted corresponds to a row. A count from 1) the selected column and 2) the location of the most recent row selection (Ground Zero with a value of 000) is processed down to the item to be encrypted. The count of rows is transferred as a 3-digit number. Given 1) the equal amount of rows and columns in the Digital Curtain encryption table, 2) with each letter/number/symbol/space character occurring only once in each row and once in each column and 3) the coordinates of the last selection (column and row) become Ground Zero (new coordinates of (000, 000), there is an equal usage of all row numbers (000-999) of the DC. For example, the 3 digits used to represent the repeated selection of the letter “e” will yield the same results as the 3 digits used to represent the repeated selection of the letter “q,”.

Creation and Usage of the Driveshaft number:
1. Creation of the 3 digits:
   a. The output from the first 10 (1-10) VW window boxes are added together and the last digit of its sum is the first digit in The Driveshaft and the name of that digit is Driveshaft Subcomponent #1 (DS #1). The value of the initial (at the beginning of the encryption) DS #1 may be used for the size contingency.
   b. The window boxes displaying the output from VW window box numbers 9-18 are added together and the last digit of the sum is used for the second digit of the Driveshaft and the name of that digit is Driveshaft Subcomponent #2 (DS #2). The value of the initial DS #2 is used to set the perimeter for the encryption count contingency.
   c. The window boxes displaying the output from VW window box numbers 17-25 and VW window box number 1 are added together. The last digit of the sum becomes the third digit of the Driveshaft and the name of that digit is Driveshaft Subcomponent #3 (DS #3). The value of the initial DS #3 may be used for the size contingency.
2. Encryption Usage:
   a. The 3 digits of the Driveshaft changes with each advancement (“Tick”) of the Googol Production Engine (GPE). After each advancement (tick) of the GPE, a new 3 digit Driveshaft is calculated and displayed.
   b. The Digital Curtain advances from the column of the last cypherment (Ground Zero, coordinates (000, 000)) in the amount of the Driveshaft.
   c. Once the Driveshaft chooses the column, the count of rows down from the last cypherment (Ground Zero) to the actual active or inactive (inert ingredient) item will determine the 3 digit value (from 000 through 999) to be entered into the encryption.
3. Decryption Usage:
   a. On the other side, the receiving side of the encryption, ONLY the Driveshaft will be used. There is no use for the odd/even results of the googol production engine (“The Decider”) or contingencies as they are only used to determine the injection of inert ingredients.
   b. The creation and usage of the Driveshaft within the Digital Curtain is the same.

The Digital Curtain (DC)—The Digital Curtain is a table of rows and columns in which each column and each row contain no more than a single entry selected from a character set subject to encryption (e.g., a letter/number/symbol/space/ii character). The starting point for all encryptions is always the same, the default Ground Zero (furthest left column and the top row with temporary coordinates of (000, 000)). Thus, when a particular column in the DC is chosen via the Driveshaft number, the count from the prior encryption (Ground Zero with a row value of 000) down to the row containing the character subject to encryption determines the cypherment output which is transferred as a 3-digit number to the Encryption Box. The DC moves only from top to bottom and left to right and continues from end to beginning in continuous circles. It uses the prior column and row selection as the base (Ground Zero with new coordinates (000, 000) from which to begin counting for the next column and row selection. The 3-digit number derived from the Driveshaft advances the DC to the next column from which the cypherment (The Chosen One) is to be chosen and a count down from the row in Ground Zero becomes the encrypted digits which is always referenced as a 3-digit value.

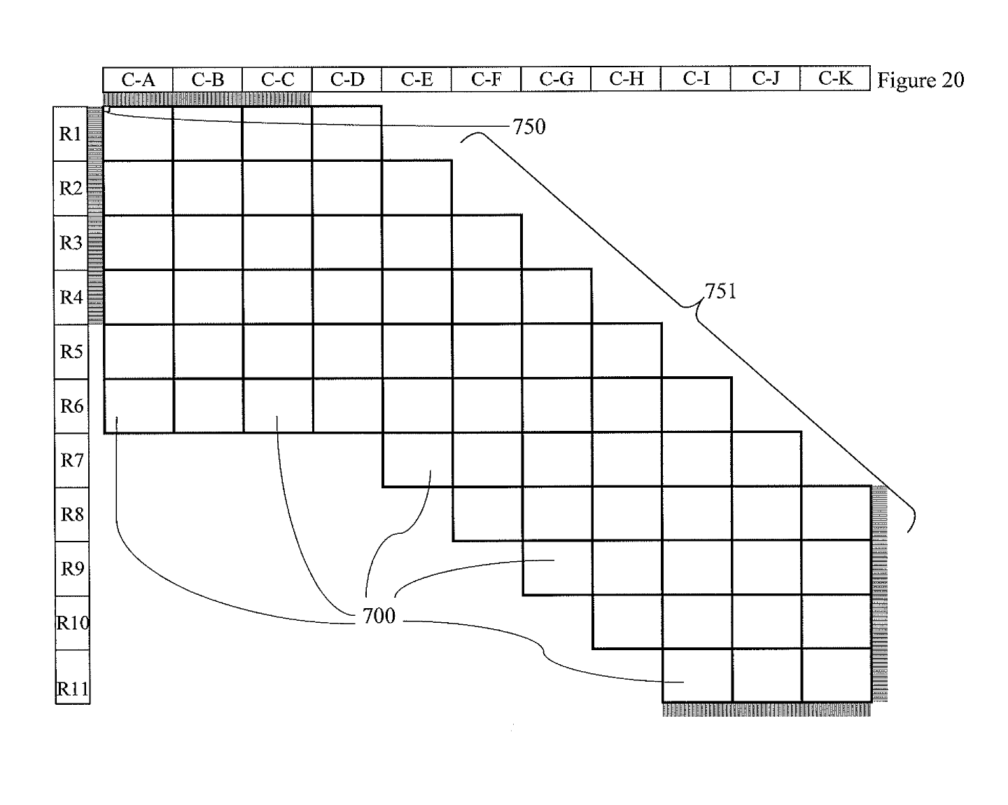

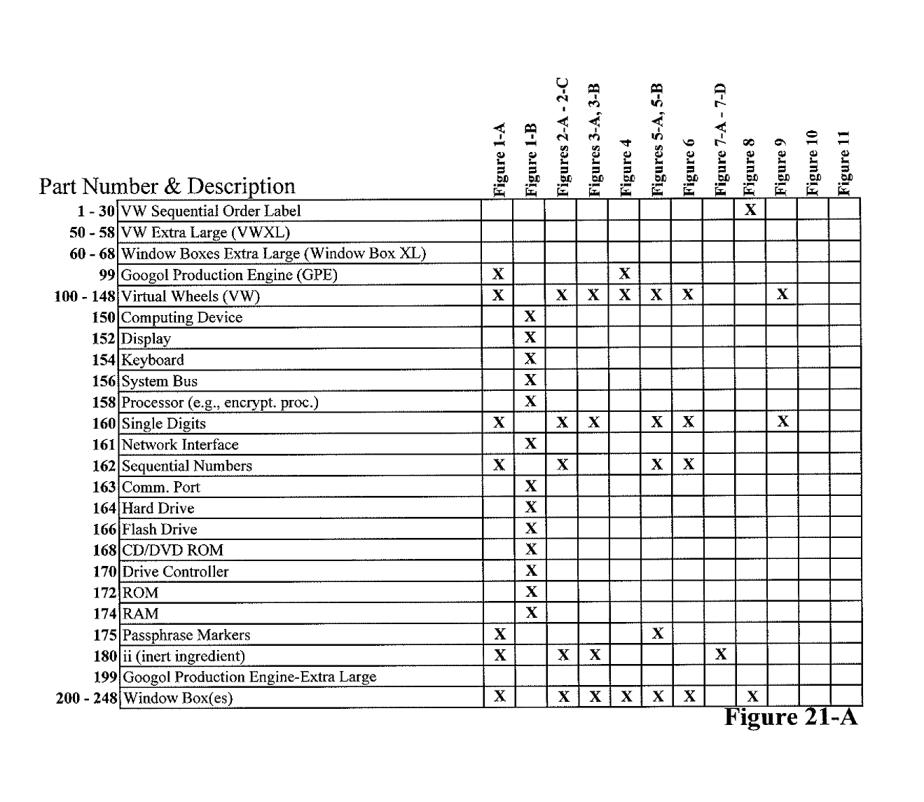

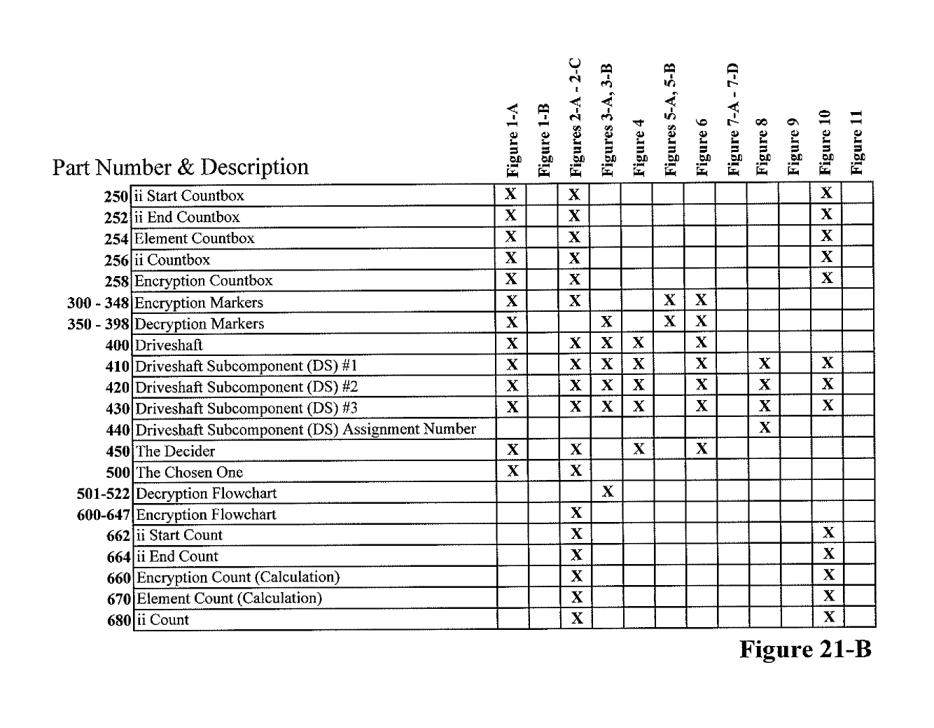

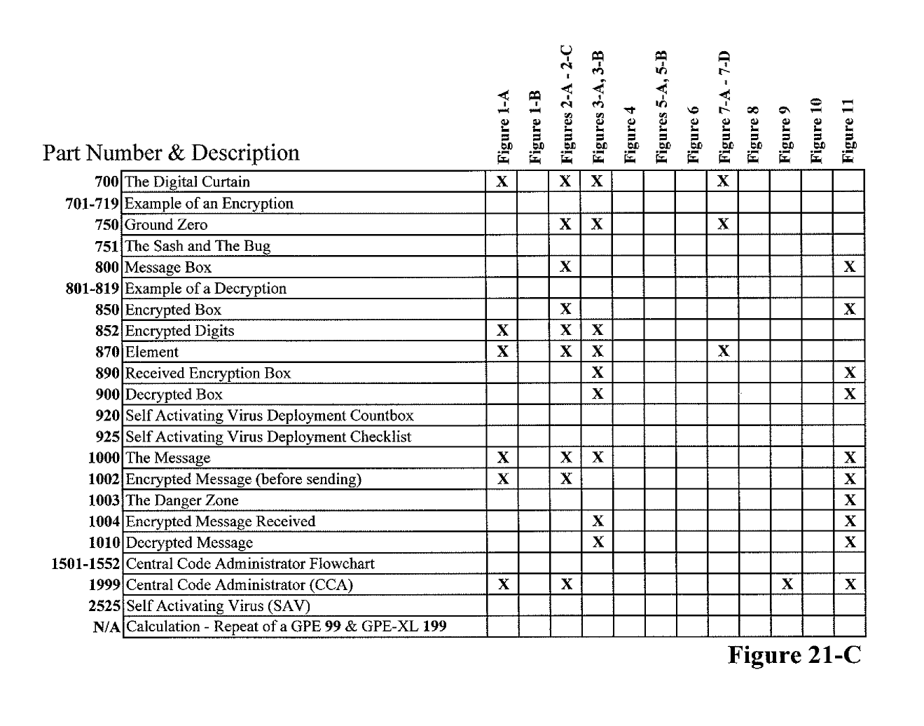

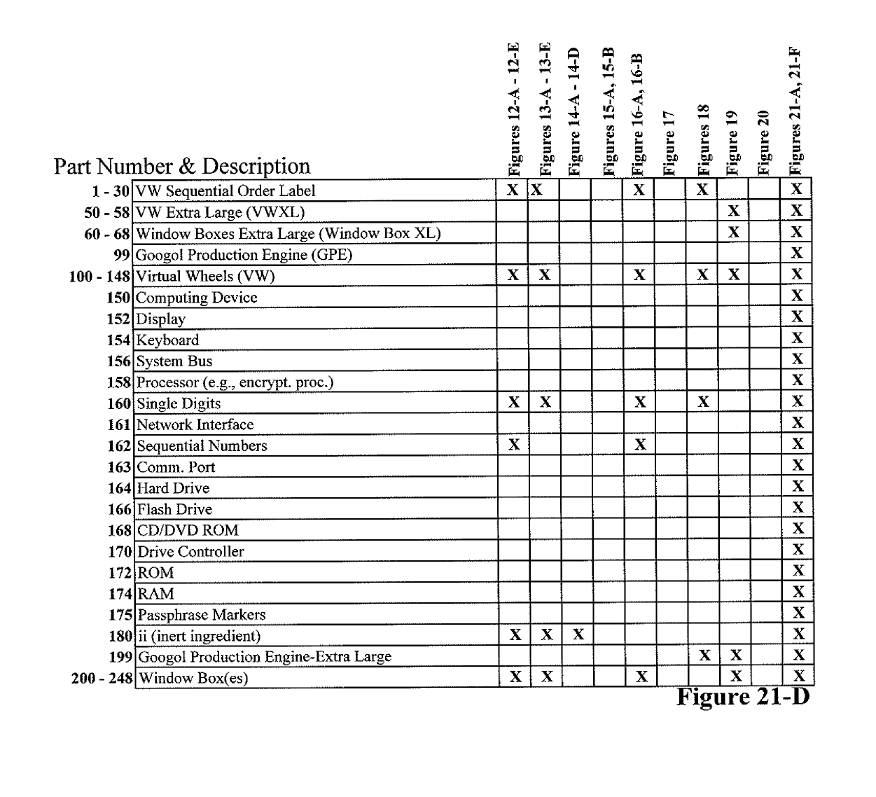

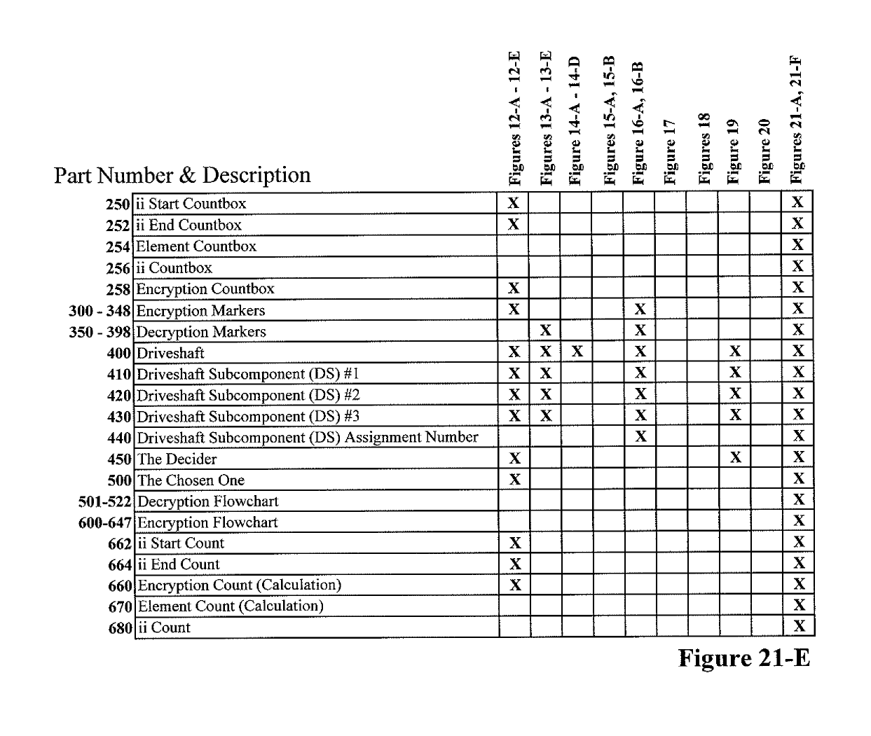

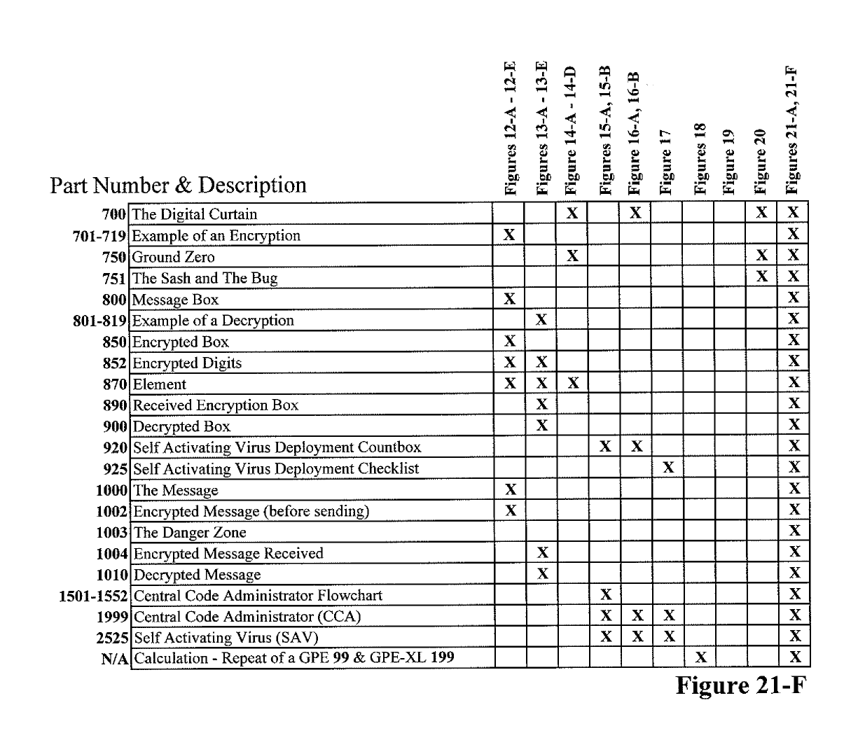

Creation of the Digital Curtain
1) In one example, create a table with 1,000 columns and 1,000 rows (in this example, the encrypted item will always be represented by a 3 digit number ranging from (000-999).
2) Enter one and only one of all variations of letters, numbers, symbols, a space, ii and characters. Whereas each row contains one of every option and each column will contain one of every option. Blank or empty boxes are acceptable. A larger table can be created with 10,000 columns, 10,000 rows, yet such a table will require a 4 digit encryption number for each cypherment. Smaller tables (500 columns, 500 rows) can be created and stacked together with one Ground Zero to create The Sash and The Bug as in FIG. 20.
3) Create “Ground Zero” with a default location for the inception of all encryptions to begin in the upper most row and furthest left column with initial coordinates of (000, 000). The location of “Ground Zero (coordinates (000, 000)” will change location to the exact location of the most recent cypherment making the coordinates of the most recent cypherment (000, 000) for the following cypherment.
4) As the count of columns and rows reach an end (bottom row or furthest right column), the count continues with a wrap back to the beginning (top row, furthest left column) creating seamless circles as the count continues.
5) The encrypted digits are represented by a 3-digit number for a 1,000 row and 1,000 column table (or a 4-digit number if the Digital Curtain is a 10,000 by 10,000 table).

Within the Digital Curtain, the upper most row and furthest left column is always the starting point of the encryption process which is known as “Ground Zero”. “Ground Zero” changes location for each cypherment. From “Ground Zero”, the driveshaft will advance the columns of the DC to the next column from which the item to be encrypted will be found. The column and row in which the chosen cypherment is located become the location of the NEW “Ground Zero”. The 3-digit Driveshaft number will always advance from the last column chosen. The “count” down of rows to the next chosen cypherment will be done from the row of the most recent selection. The intersection (column and row) of the most recent selection is “Ground Zero” and carries the coordinates of (000,000).

Creating an Embodiment of the Webcloak Encryption System
1) Create the Googol Production Engine—The 25 Virtual Wheels (VW) are at the heart of the Googol Production Engine that powers the two main processes of the provably unbreakable code. Each process is unique as it creates the generated numbers needed to calculate two essential components, The Decider (selections are made based on its odd/even results) and the Driveshaft (the 3-digit number that advances the columns in the Digital Curtain). Each part individually has the ability to create a provably unbreakable code. The Decider adds “smoke” (e.g., a lot of filler) masking the length of the encryption as well as concealing the actual encrypted message. Both The Driveshaft and The Decider processes ensure that, with extensive use, the occurrence of all 3-digit encrypted numbers are equal, thereby greatly increasing the strength of the encryption. For example, When the Driveshaft is used in conjunction with the Digital curtain, the combination ensures that the probability that the 3-digit encryption number used to represent a lower case “e” occur equally to the 3-digit encryption number that would be used for the upper case letters “z” and “q”. Both “The Decider” and The Driveshaft have a repeat of a minimum of a googol. The repeat is easily expandable to (1.0×10¹²⁰) simply by increasing the number of virtual wheels within the Googol Production Engine to Googol Production Engine—Extra Large (GPE—XL). The repeat of a (1.0×10¹²⁰) results in a number larger than all the grains of sand on earth, creating a provably unbreakable code. Besides the extra large size, the distinctive benefit is the value of each Window Box and each Window Box Extra Large is allocated to only one Driveshaft Subset.

A) VW #100
a) For Virtual Wheel #1 (VW 1), create a virtual string of an equal quantity of 10,000 random single digit numbers from 0-9. The string is continuous and ends where it begins (a “Wheel”).
b) Assign a number to each single digit from 00001 through 10,000 in consecutive order known as sequential numbers
c) Create Passphrase Markers by creating all possible double digit combination of the letters a-z (26), the numbers (0-9) and a space (one digit) (but not limited too) (26 letters, 10 digits, one space) for a total of 37 variables. Using the 37 variables, a total of 1,369 two alpha/numeric/space combinations are possible. An example of some of the expected outcome is as follows: aa, ab, ac, ad, . . . , az, a0, a1, a2, . . . , zz, z0, z1, z2, z3, . . . , 99, 9(space),(space)(space), (space)1, (space)2, (space)3 . . . ) for a total of 1,369 combinations. The 2-digit Passphrase Marker pairs are randomly distributed in equal (or near equal) distribution among and aligned with the Single Digits and Sequential Numbers approximately 7-8 digits apart. The markers are “attached” to the single digits as are the Sequential Numbers. The number of passphrase combinations within the GPE with 1,369 Passphrase Markers per Virtual Wheel is (2.57091×10⁷⁸). In a hypothetical situation where document(s) are to be stored within the memory of a computer/detachable device containing a Webcloak, the Virtual Wheels of the Webcloak can be configured to a single-use passphrase consisting of a minimum of 50 digit alpha/numeric phrase. The document would be safely stored in the memory (or sent electronically) of the computer until the exact passphrase is entered and the encrypted message is decrypted. In another hypothetical situation, a file can be coded with a specific passphrase. Although an authorized end user may sign into the Central Code Administrator, the use of a passphrase would ensure that the document sent is decrypted only by the person who knows that specific passphrase. In an embodiment, the passphrase is employed when a document has already been saved within the computer/detachable device.
d) Create a single “Window” Box (output) for the VW. The “Window” Box will display/output only one single digit number at a time in sequential order with a continuous repeat from end to beginning always in the same direction.
e) Create one encryption marker and one decryption marker for each VW. The Encryption Markers and Decryption Markers mark the location of a window box upon its corresponding VW at the time the encryption/decryption is completed. At any given time, only one marker is affixed to the single digit number and its corresponding sequential number.

B) VW #2-25
a) The steps for the creation of VW2 through VW25 are the same as above with the exception of the total number of single digits 0-9 (as well as the corresponding sequential number). Each sequential VW will contain at least one (1) digit more than the prior VW with no two VWs containing the same cumulative amount of digits. Thus, VW2 contains 10,001 single digits 0-9 in near equal (only one digit difference) quantity. VW3 contains a minimum of 10,002 single digits, VW4 contains 10,003 single digits . . . and VW25 contains a minimum of 10,024 single digits 0-9 of equal/near equal quantity with each single digit identified by a sequential number which can be used to identify the exact location of any part upon the VW.
b) Each VW has its own random order of the single digits 0-9. There are no duplicate quantities of cumulative total digits.

2) Create the Digital Curtain (DC)—The DC is the table from which the encryption is selected.

A) Create “The Decider”—“The Decider” is the process that will determine if the next encryption should be inert (ii) or active (a character from the message to be encrypted). It is only used during the encryption process. Numerous contingencies are in place to ensure that, when the odd/even results of “The Decider” inevitably repeats itself for numerous and continuous cypherment, the contingencies kick in to ensure that the actual encryption does not contain more than 80% ii nor less than 20% ii. By limiting the number of sequential selection of the same outcome (all odd or all even) of “The Decider” to 4, these perimeters can be achieved. The ii countbox and element countbox have been preset to allow no more than 4 selections of the same outcome.
a. Add all the single digit output values among all VW Window boxes (1-25) together. The sum of which will be anywhere from 0 through 225. The odd/even results (equal probability of both outcomes) of the selection will determine whether the next digit to be encrypted will be an inert ingredient (ii) or an active ingredient (e.g., a letter/number/symbol/space character supplied by the user). There are contingencies and countboxes in place to ensure that, when the GPE inevitably enters into a long string of the same odd/even outcome, the integrity and length of the encryption process is not jeopardized.

B) Create the Driveshaft—The Driveshaft is the 3 digit code which advances then selects the column from the Digital Curtain the encryption is to be chosen from. Each of the 3 digits is derived from the last digit of the sum total of a select number of VW window boxes. There are 10 window boxes in each selection to ensure that there is a near equal chance that the last digit of the sum total is 0-9. Once the column is chosen, a count of rows down from the prior selection (now known as Ground Zero with coordinates (000, 000)) to the row matching the corresponding item to be encrypted is entered as a 3 digit number into the encryption box. Like the VWs, the Digital Curtain is connected from the last column on the right to the first column on the left and from the bottom row back to the top row. The count of columns is always done from left to right and the count of rows is always a downward count of rows. The intersection of the column and row that was chosen becomes Ground Zero (coordinates (000, 000) for the next cypherment.

Thus, the Driveshaft number powers the advancement of the Digital Curtain. In an embodiment, the first digit of the Driveshaft is the last digit of the sum of VWs window boxes 1-10 (10 total single digits). The second digit of the Driveshaft is the last digit of the sum of VWs window boxes 9-18 (10 total single digits). The third digit of the Driveshaft is the last digit of the sum of VWs window boxes 17-25 and VW window box 1 (10 total single digits.

C) Movement of each VW individually and all VWs simultaneously: With each item that is to be encrypted, all 25 VW move from one digit to the following digit in sequential order. Each movement is referred to as a “tick.” Each VW output window box displays the corresponding sequential single digit with each “tick.” Thus, on VW1, the repeat occurs with every 10,000 ticks. The repeat on VW2 is 10,001 ticks. The repeat on VW3 is 10,002 ticks, and so on.

### Further Embodiments

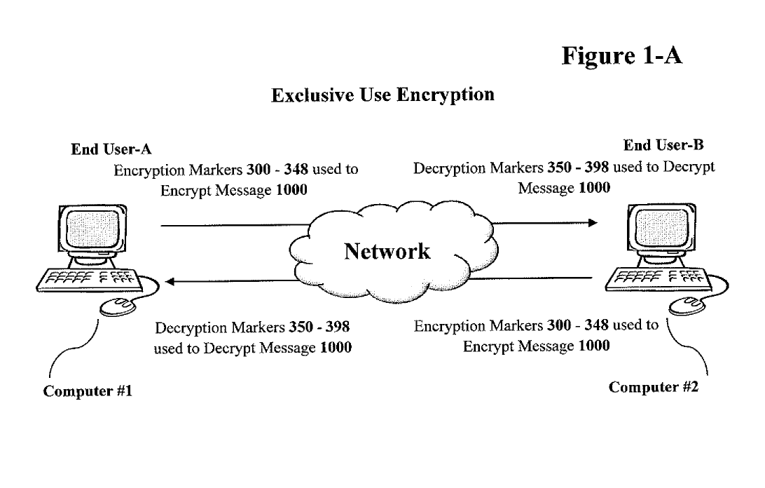

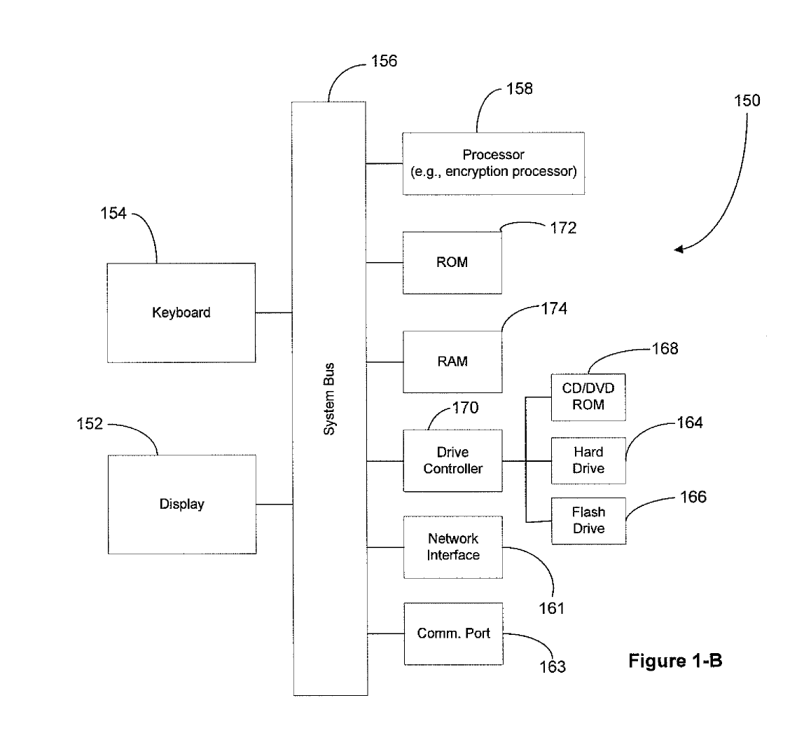

Turning to FIG. 1-A, a diagram illustrating an embodiment of the Webcloak cypherment technique described herein is shown with reference to a computer system comprising at least two communicatively connected computing devices (e.g., either directly via peripheral or short-range wireless input, such as but not limited to USB, UWB, Bluetooth, or via a network, such as but not limited to a LAN, WAN, WWAN, a payment processing network, or the Internet). The two computing devices, (e.g., computers, smartphones, electronic payment terminals, or the like) have identical Webcloak encryption/decryption systems described above except for the placement of their Encryption Markers 300-348 and Decryption Markers 350-398. The Encryption Markers 300-348 of computer #1 match exactly with the location of computer #2's Decryption Markers 350-398 upon their corresponding Virtual Wheels 100-148. The Decryption Markers 350-398 of computer #2 will match exactly with the location of computer #1's Encryption Markers 300-348 upon their corresponding Virtual Wheels 100-148. Since communication is exclusive between only computer #1 and computer #2, the placement of all markers 300-398 is adjusted with each encryption and decryption process. The end placement of all markers 300-398 upon their corresponding virtual wheels is saved after each encryption or decryption process.

Process: Turning to FIG. 1-A, an End User-A enters the Message 1000 into the Webcloak. In embodiments, the Message 1000 comprises information entered by the user into one or more user interfaces of the computing device, including but not limited to an email text, email file attachments, as well as credit card information entered via a web browser form, or the like. The Message 1000 is encrypted from the Webcloak contained in either computer #1 or from a detachable device which is connected to computer #1. From within said Webcloak, adjustments are made to the positioning of the Window Boxes 200-248 along its corresponding Virtual Wheels 100-148 to the placement of Encryption Markers 300-348. The Encrypted Message 1002 is sent electronically to computer #2. Computer #1 saves the placement of all Encryption Markers 300-348 on the Webcloak.

Upon receiving Encrypted Message Received 1004, Computer #2 adjusts its Window Boxes 200-248 along its corresponding Virtual Wheels 100-148 to the placement of its Decryption Markers 350-398 to decode the Encrypted Message Received 1004. End User-B then reads Decrypted Message 1010. Computer #2 saves the current placement of all Decryption Markers 350-398 on the Webcloak.

If End User-B wishes to reply back to End User-A, the process above is repeated with a change to the reference of the end users and computers. “End User-A” becomes “End User-B” and vice versa. “Computer #1” becomes “Computer #2” and vice versa. Again, all markers 300-398 are saved on their corresponding computer's Webcloak.

Turning to FIG. 1-B, an embodiment of hardware components for implementing embodiments of the invention described herein is shown with reference to a computing device 150. The computing device 150, such as a computer or a dedicated special-purpose ciphering apparatus, includes a plurality of hardware elements, including a display 152 for presenting to the user an interface for displaying data subject to encryption and/or decryption in accordance with embodiments described herein, as well as a keyboard 154 for relaying the user input via the user interface. The display 152 and keyboard 154 peripherals connect to the system bus 156. An encryption processor 158, such as a central processing unit (CPU) of the computing device or a dedicated special-purpose encryption processor, executes the computer executable instructions comprising embodiments of the Webcloack encryption/decryption process described herein. In embodiments, the computer executable instructions are received over a network interface 161 (or communications port 163) or are locally stored and accessed from a non-transitory computer readable medium, such as a hard drive 164, flash (solid state) memory drive 166, or CD/DVD ROM drive 168. The computer readable media 164-168 are accessible via the drive controller 170. Read Only Memory (ROM) 172 includes computer executable instructions for initializing the processor 158, while the Random Access Memory (RAM) 174 is the main memory for loading and processing instructions executed by the processor 158.

Encryption Process

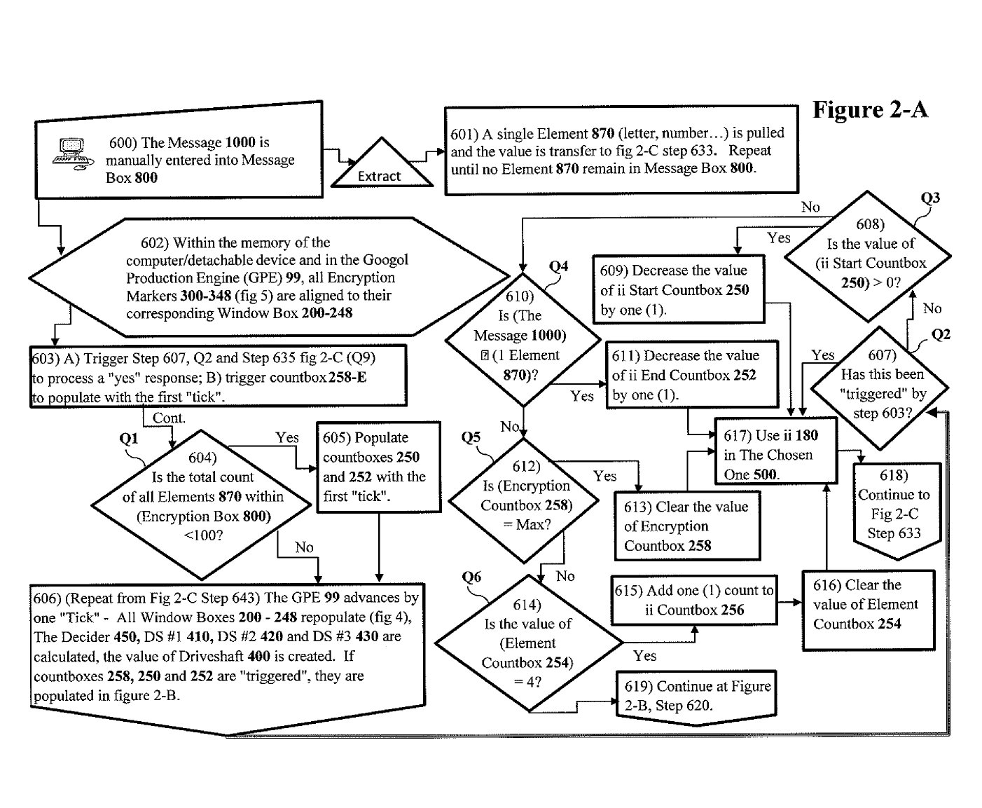

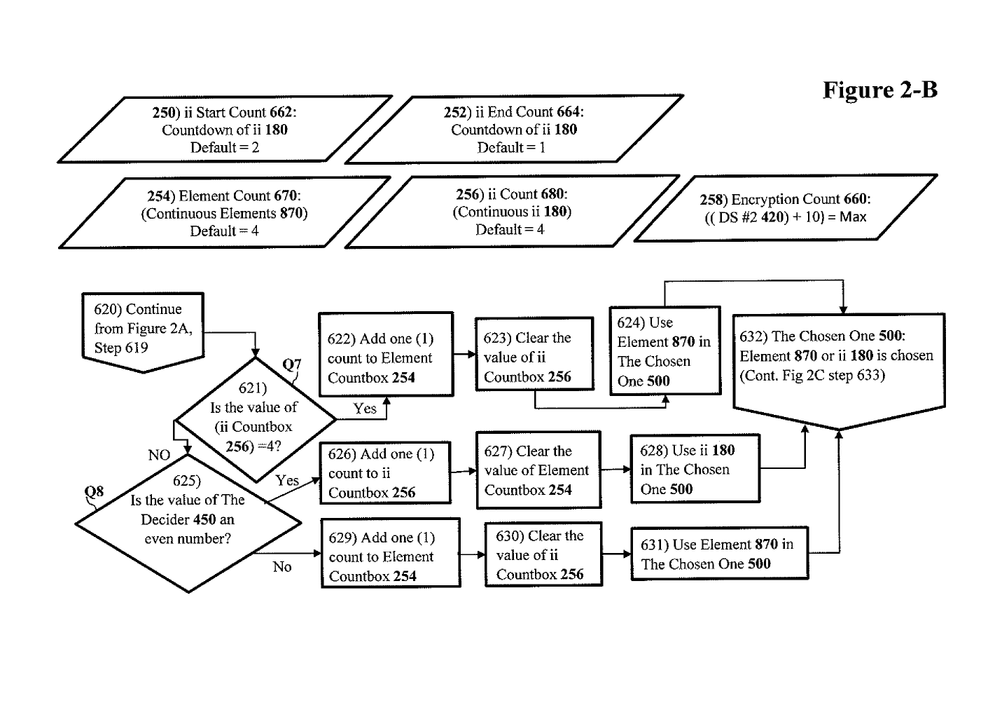

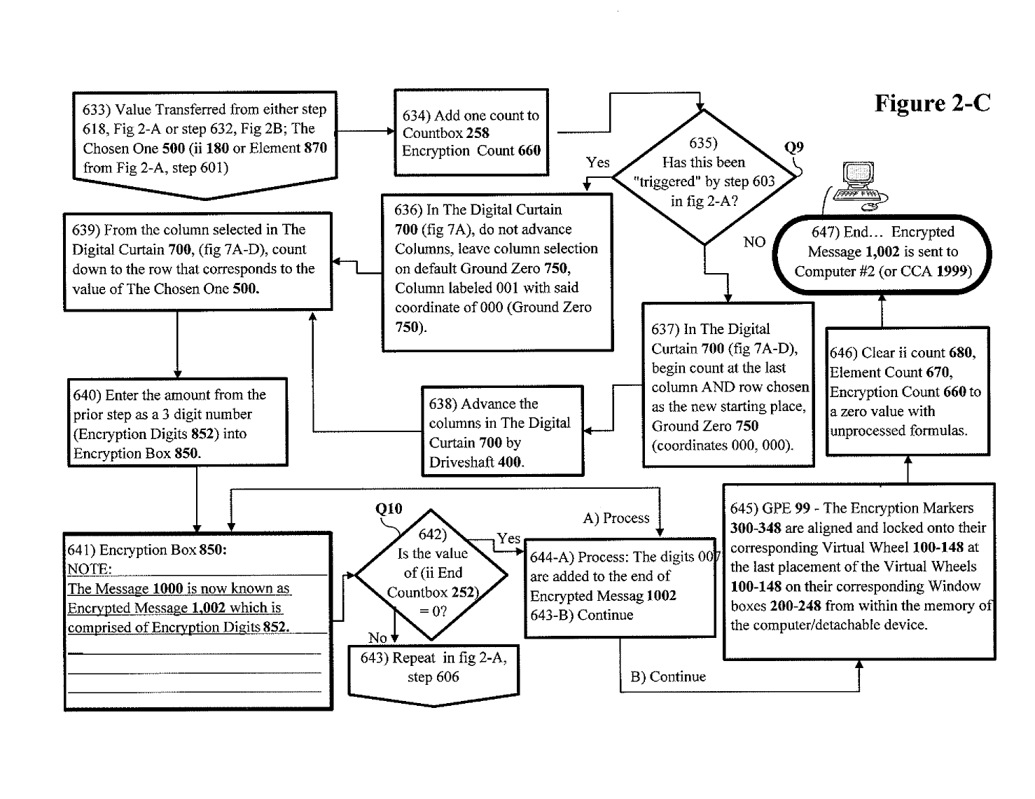

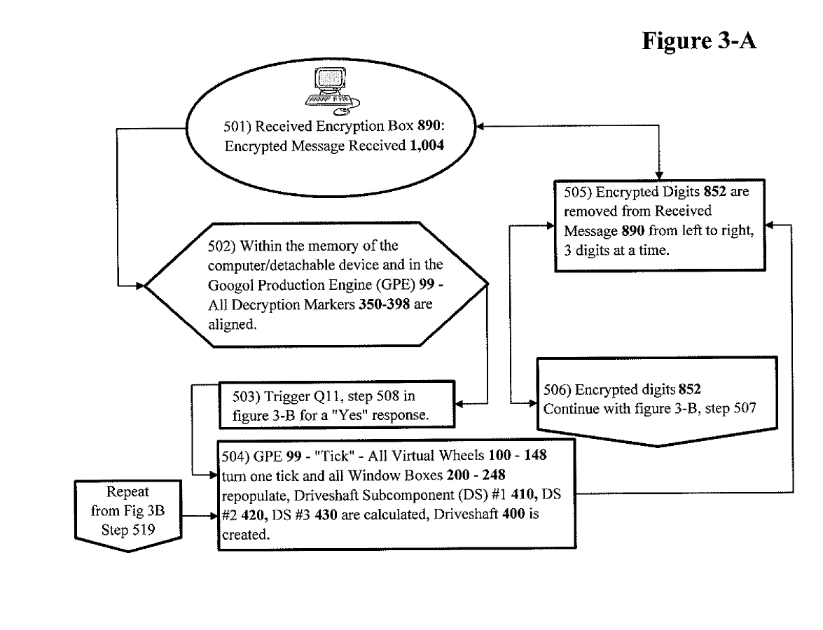

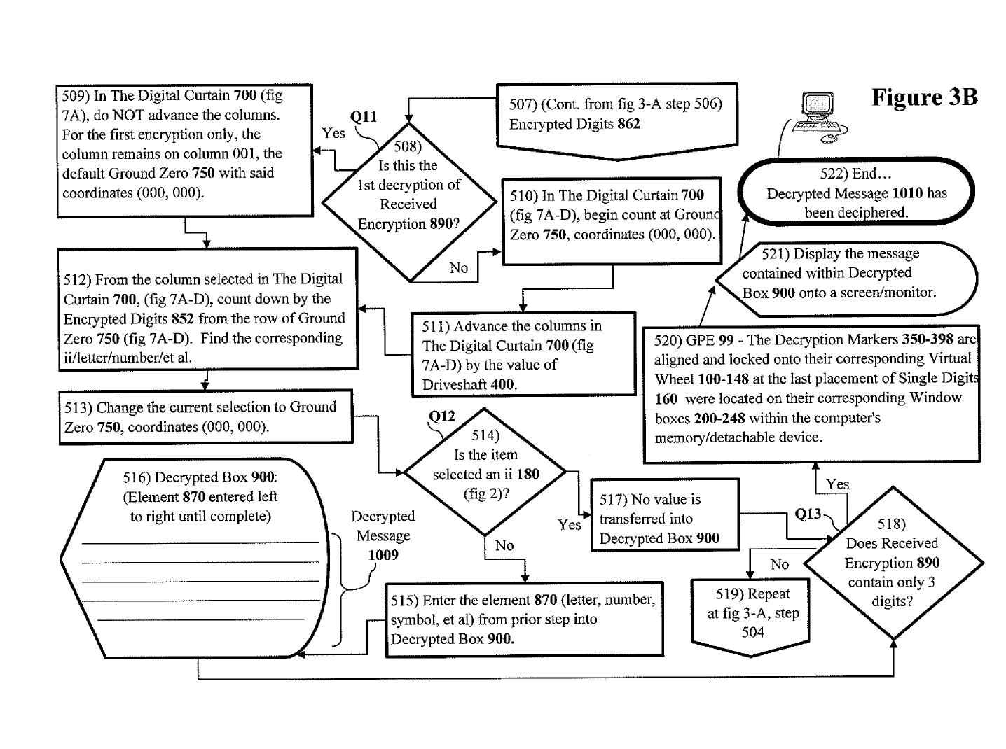

Turning to FIG. 2-A an embodiment of an encryption process is shown. In step 600, the Message 1000 is entered into the Message Box 800 with said Message Box 800 serving as the holding place of The Message 1000 throughout the encryption process. Said Message Box 800 serves as the place from which each Element 870 (letter, number, space, symbol, et al) will be removed one Element 870 at a time from left to right, top to bottom as shown in step 601. Each Element 870 is transferred to FIG. 2-B, step 631 and waits until it is selected for use in the encryption process. Each time an Element 870 becomes The Chosen One 500 and pulled from FIG. 2-B, step 631, then another Element 870 is pulled from The Message 1000, step 601, and its value transferred to FIG. 2-B step 631 until all Element 870 from The Message 1000 have been pulled.

After The Message 1000 has been entered, all Virtual Wheels 100-148 align all Encryption Markers 300-348 with their corresponding Window Boxes 200-248 so as to adjust all Single Digits 160 and their corresponding Sequential Number 162 at the exact placement of the last encryption, step 602. During the encryption process, the Encryption Markers 300-348 are “unlocked” from their current position and are positioned with the Window Box 200-248 until the encryption process is complete.

In step 603 A-B, several one-time triggered events are created upon the initial start of the encryption process. The first triggered event ensures that, by default, the first encrypted item of every encryption will always be an ii 180. The second triggered event provides a value for Countbox 258, the Encryption Count 660.

Step 604 refers to the third trigger which is contingent upon the yes/no response of the first question “Is the total count of all Elements 870 within Message Box 800 <100?” A count of all Elements 870 within The Message 1000 is processed which includes (but not limited to) letters, numbers, digital files, symbols, spaces, pictograms, characters, and changes in font (style, size, bold, italicized). The answer to the question is for the establishment of acceptable perimeters for smaller messages. If the answer is “No”, the default presets of two (2) will be the value of ii Start Count 662 and one (1) will be the default value of ii End Count 664. In step 605 a “Yes” response prompts results in the triggering of ii Start Countbox 250 and ii End Countbox 252 to be populated only upon the initial “tick”. Countbox 250 is the ii Start Count 662 used to mask the size of a small encryption. The formula equals (Driveshaft Subcomponent (DS) #1 410)+3. The ii Start Countbox 250 has a default value of two (2) which ensures that the initial odd/even column selection for Element 870 and ii 180 is not predetermined. The ii End Countbox 252 holds the value of ii End Count 664 which is also used to mask the size of a small encryption. The formula used to calculate its value is (Driveshaft Subcomponent (DS)#3 430)+3. ii End Countbox 252 has a default value of one (1).

The values generated by the triggered events are used to establish acceptable perimeters referenced throughout this encryption process. The only presets are the default values of some of the countboxes. The creation of variable values within each encryption offers yet another variable to the entire encryption process rendering the Webcloak with stronger protection. The values of the one-time triggered event are calculated and set with only the initial “tick” (the advancement of all Virtual Wheels 100-148). The initial established values become the acceptable limit throughout the encryption process and said values are transferred to their corresponding Countboxes. Upon completion of the encryption process, the value of Countboxes 250, 252, and 258 are cleared and replaced with their default values.

Step 606 is the first step of all encryption repeats. Within the Googol Production Engine (GPE) 99, all Virtual Wheels (VW) 100-148 turn one “tick” resulting in the advancement of all Single Digits 160 and their corresponding Sequential Number 160 to advance one digit through their corresponding Window Boxes 200-248, always in the same direction and always in sequential order. Said Window Boxes 200-248 remain fixed in place as only the VW 100-148 rotate through it. In the process, all Window Boxes 200-248 are repopulated with a new Single Digit 160. The Encryption Markers 300-348 which initially adjusted the VW 100-148 to the proper alignment with said Window Boxes 200-248 remain aligned with their Window Boxes 200-248 until the encryption process is completed at which time they will become attached to their corresponding VW 100-148 at the last placement of the VW 100-148 upon its corresponding Window Box 200-248. The results of the “tick” and subsequent change in the value of all Window Boxes 200-248 are as follows:

The Decider 450 is calculated using the sum of Window Boxes 200-248. The output range is a value from 0-225 with an overall average of 112.5. Thus, the odd/even numeric outcome is equally probable. The odd/even results will be used in future step 622, Q8 within FIG. 2-B.

The values of Driveshaft Subcomponent (DS) #1 410, Driveshaft Subcomponent (DS) #2 420 and Driveshaft Subcomponent (DS) #3 430 are created using the populated results of the “tick” of all Virtual Wheels 100-148.

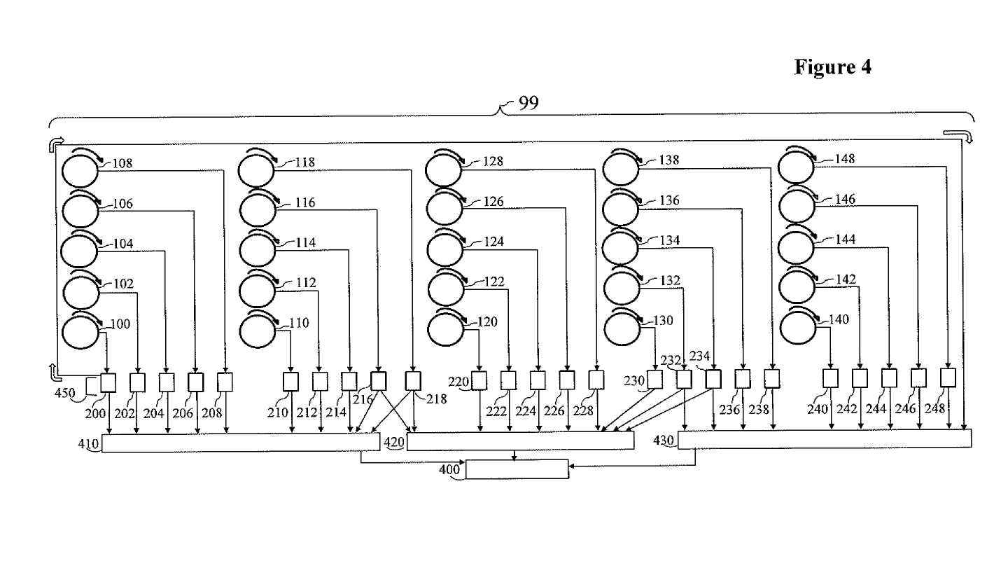

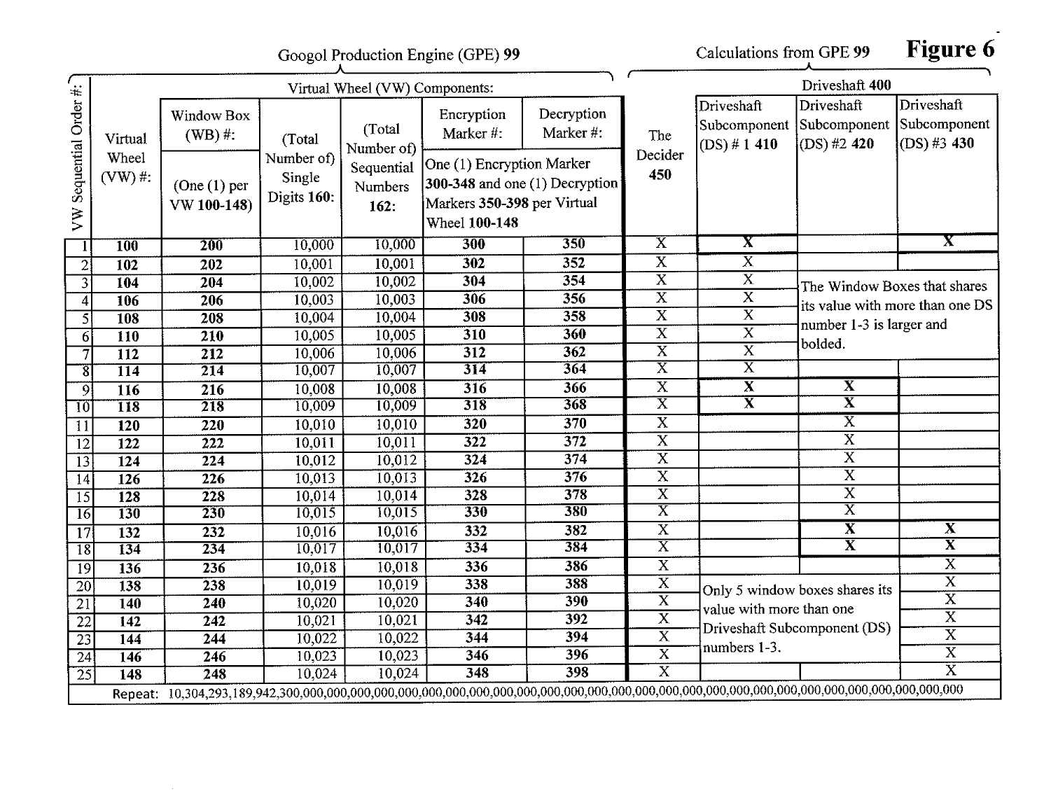

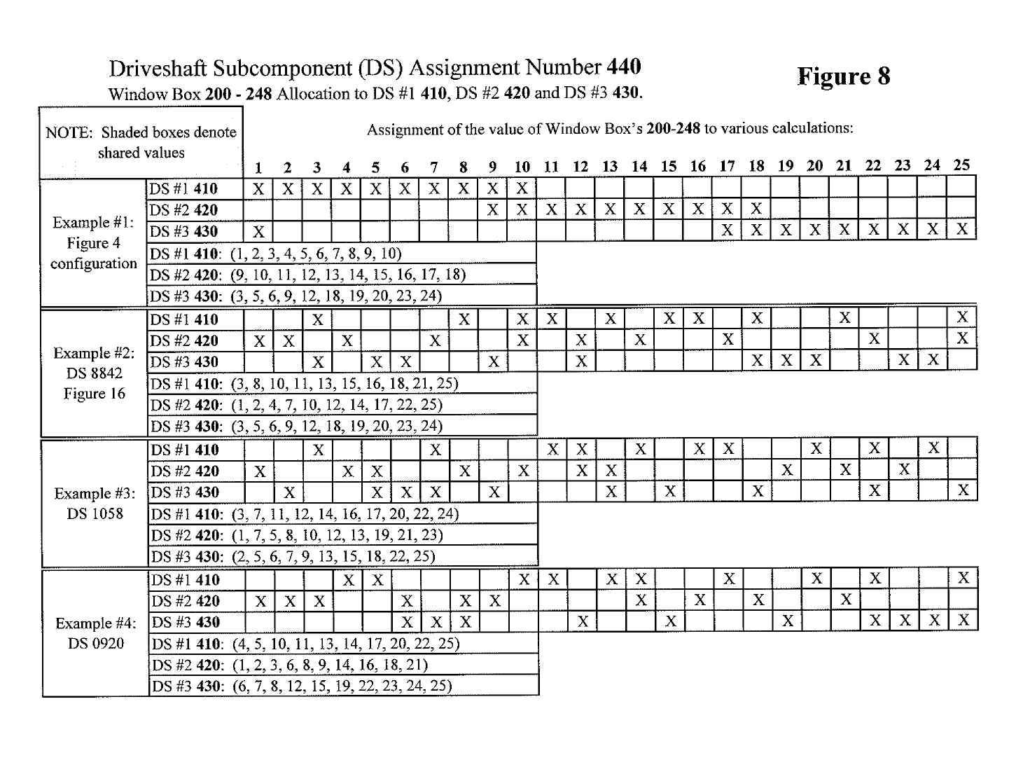

Turning to FIG. 4, FIG. 6 and FIG. 8 Example #1, an embodiment of an allocation of the value of all Window Boxes 200-248 via the Driveshaft Subcomponent (DS) Assignment Number 440 is shown. The value of Driveshaft Subcomponent (DS) #1 410 is the last number (digit) of the sum of Window Boxes 200-218 (10 boxes total). The actual sum is a range in value from 0 (zero) through 90. Only the last digit of the sum becomes Driveshaft Subcomponent (DS) #1 410. This single digit number, Driveshaft Subcomponent (DS) #1 410, has two uses. First, it is the first number of the 3 digits needed to create Driveshaft 400. Second, upon the first encryption, it has a potential use in the calculation of the ii Start Count 662 (contingent upon the size of the encryption).

The value of Driveshaft Subcomponent (DS) #2 420 is the last digit of the sum of Window Boxes 218-236 (10 boxes total). This single digit number, DS #2 420, has two uses. First, it is the second number of Driveshaft 400. Second, upon the first encryption, its value is used to calculate the Encryption Count 660 value (10+DS #2 420).

The value of Driveshaft Subcomponent (DS) #3 430 is the last digit of the sum of Window Boxes 234-248+Window Box 200 (10 boxes total). This single digit number, DS #3 430, has two uses. First, it is the last (3^{rd}) number of Driveshaft 400. Second, upon the first encryption, it has a potential for use in calculation of ii End Count 664 (contingent upon the size of the encryption).

Driveshaft 400 is created by stringing the three single-digit numeric values of DS #1 410, DS #2 420 and DS #3 430 together to form one three digit number which is now known as Driveshaft 400. The Driveshaft 400 is always a 3 digit number with a value ranging from “000” through “999” with a near-equal distribution of all numeric possibilities. The creation of DS #1 410, DS #2 420 and DS #3 430 results in a slight favoring of the number “5” with a least occurrence of the number “0”. The creation of Ground Zero 750 within the Digital Curtain 700 overcomes the inevitable slight favoring of certain columns. Driveshaft 400 is used to power the advancement of the columns within the Digital Curtain 700.

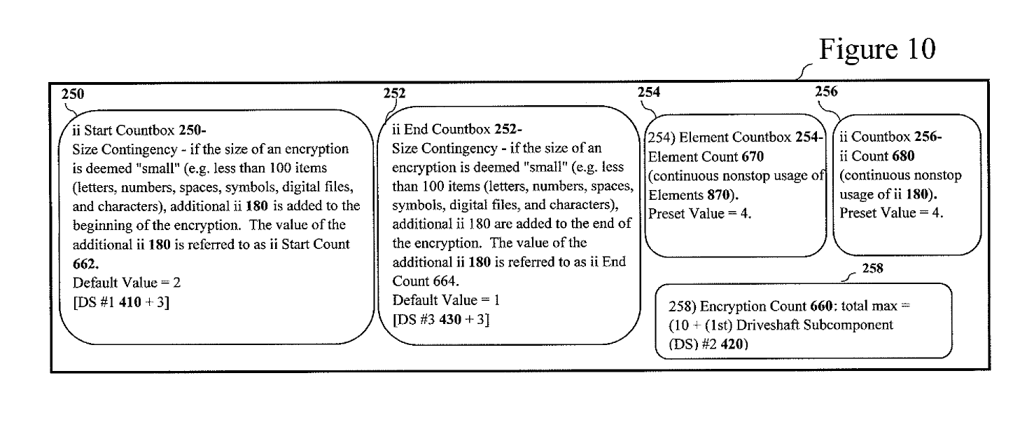

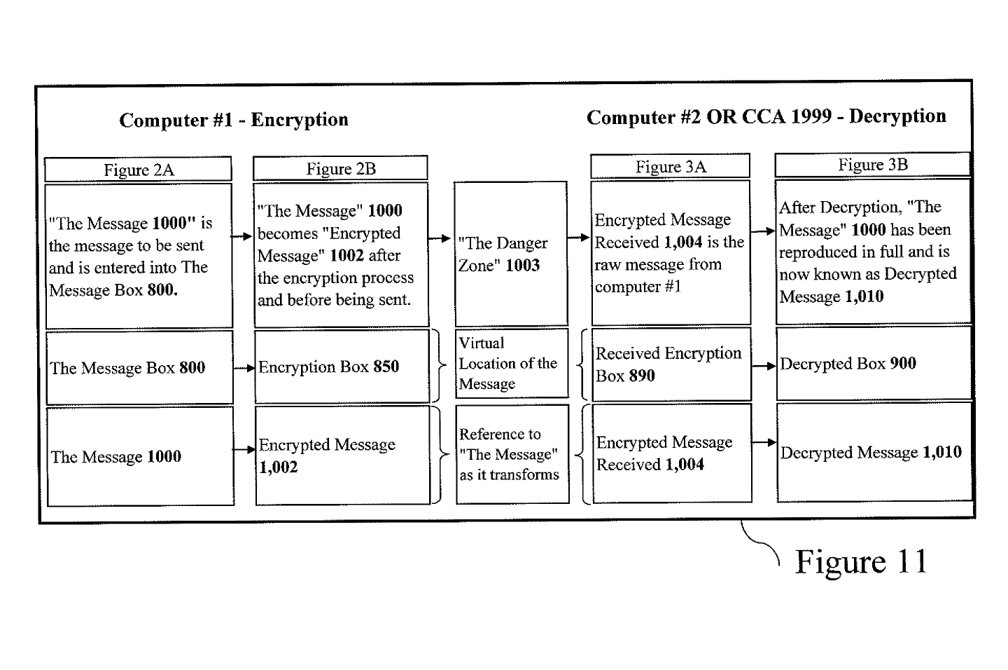

Turning to FIG. 2-B and FIG. 10, an embodiment of countboxes used in the encryption process is shown.

ii Start Countbox 250—The maximum acceptable value for ii Start Countbox 250 is determined by the value of ii Start Count 662 which is contingent upon 1) if the “tick” is the first “tick” of the encryption process and 2) if step 605 is triggered as a result of a “Yes” response to step 604, Q1. The value of ii Start Count 662=(DS #1 410)+3. By default the value=2. The default value ensures that the initial odd/even column selection of “The Decider” is not predetermined.

ii End Countbox 252—The maximum acceptable value of ii End Countbox 252 is determined by the value of ii End Count 664 which is contingent upon 1) if the “tick” is the first “tick” of the encryption process and 2) if step 605 is triggered as a result of a “Yes” response to step 604, Q1. The value of ii End Count 664=[(DS #3 430)+3]. By default the value=1.

Element Countbox 254—The maximum countbox value for Element Count 670 has a preset value of 4. Each time an Element 870 is chosen for encryption via an odd value of “The Decider” 450, a single count is added to the value of Element Countbox 254 and the value of ii Countbox 256 is cleared. Upon the creation of the Webcloak, the maximum value of 4 would have been assigned as an acceptable continuous usage of an Element 870 before contingencies override the selection of “The Decider” 450 and automatically adds an ii 180 to the Encrypted Message 1002. The default maximum value of 4 ensures that a minimum of 20% ii 180 fills the Encrypted Message 1002 and Encrypted Message Received 1004.

ii Countbox 256—The maximum acceptable Countbox value for ii Count 680 has a preset maximum value of 4 and provides a count of the continuous nonstop selection of ii 180 via an even outcome of “The Decider” 450. By default, the maximum value of 4 has been assigned as an acceptable continuous usage of ii 180 before contingencies automatically adds an Element 870.

Encryption Countbox 258—The maximum value of (all encryptions) allowed within Encryption Countbox 258 before contingencies automatically selects an ii 180 is determined upon the first (initial) “tick” of the GPE 99. The Encryption Countbox 258 is a continuous count of all encryptions which consists of both ii 180 and Element 870. Encryption Countbox 258 exists so that the columns selected for the ii 180 and Element 870 do not form a pattern. The maximum value of the countbox, Encryption Count 660, is calculated upon the first “tick” of the GPE 99 using the formula [(DS #2 420)+10].

Returning to FIG. 2-A, In Step 607 the second question establishes if this is the first encrypted item within the encryption process. “Has this been “triggered” by step 603?” If the answer is “Yes”, then an ii 180 is selected and ii 180 becomes The Chosen One 500 as referenced in step 617. As prompted in step 618, proceed to FIG. 2-C, step 633. If the answer is No, continue with step 608.

In step 608, the third question begins the encryption process with the addition of ii 180 to the encryption to disguise its true size. Is the value of ii Start Countbox 250)>0? (Refer to FIG. 2-B, ii Start Countbox 250 and the value of ii Start Count 662 to answer this question.) With a default value of two, it ensures that the odd/even column selection for the first set of encryptions will not default to all ii 180 entries coming from even numbered columns and all Element 870 selections are from odd numbered columns. In step 609, if the answer is “Yes”, in FIG. 2-B—subtract one count from ii Start Countbox 250, back to FIG. 2-A, step 617, an ii 180 is selected for use in The Chosen One 500. As prompted in step 618, proceed to FIG. 2-C, step 633. If the answer is “No”, continue.

In step 610, the fourth question is a test to determine if The Message 1000 is empty. If everything that has to be encrypted is encrypted, the process shifts to start the encryption completion process. Is (The Message 1000) less than (1 Element 870)? If all components of the original “The Message 1000” have been encrypted and the answer is “yes”, continue to step 611. Decrease the value of ii End Countbox 252 by one (1) from Countbox 252 in FIG. 2-B. In FIG. 2-A (step 617), use ii 180 in The Chosen One 500. As prompted in step 618, proceed to FIG. 2-C, step 633. If the answer is “No”, continue.

In step 612, the fifth question ensures that the possibility of a change in the odd/even selection of columns for ii 180 vs. Element 870 has the potential to change long before any pattern occurs. The automatic incursion of an ii 180 is set for every 10-19 encryptions regardless of the selection of “The Decider” 450. Is Encryption Countbox 258 =Max? The term “Max” refers to the maximum total allowed as set during the first “tick” of the initial encryption process. The formula of said “Max” is [(DS #2 420)+10] as determined at the first encryption. Answer this question by referring to FIG. 2-B, Encryption Countbox 258. In step 613, if the answer is “Yes”, in FIG. 2-B, the value of the continuous count of Encryption Countbox 258 is cleared resulting in a zero balance (the count will continue with both this and future encryptions). In step 617, use ii 180 as The Chosen One 500. As prompted in step 618, proceed to FIG. 2-C, step 633. If the answer is “No, continue.

In step 614, the sixth question ensures that the minimum amount of ii 180 used in the encryption is no less than 20%. In addition, a continuous run of an odd numeric value for The Decider 450 would not adversely affect the encryption process. Is the value of (Element Countbox 254)=4? Answer this question by referring to FIG. 2-B, Element Countbox 254. In steps 615 and 616, if the answer is “Yes”, then add one (1) count to ii Countbox 256 in FIG. 2-B, then clear the value of the Element Countbox 254 to a “0” value. Follow up with step 617 by using ii 180 as The Chosen One 500. As prompted in step 618, proceed to FIG. 2-C, step 633. If the answer is “No”, as prompted in step 619, continue the process with FIG. 2-B, step 620.

Turning to FIG. 2-B, an embodiment of the encryption process continues from FIG. 2-A with step 620. In step 621, the seventh question is another contingency question used to ensure that the maximum amount (without regard to any ii 180 possibly included from the size contingency) of ii 180 items in an encryption is over 80%, but still within an acceptable range. Is the value of ii Countbox 256)=4? Refer to ii Countbox 256 to answer the question. If the answer is “Yes”, than add one (1) count to Element Countbox 254, clear the value of ii Countbox 256 to a “0” value, then use Element 870 in The Chosen One 500 as referenced in steps 622-624. Continue to step 632, The Chosen One 500. Proceed to FIG. 2-C, step 633. If the answer is “No”, continue.

In step 625, the eighth question pertains to the encryption process. The other questions pertain to the use of contingencies set in place to keep the outcome within acceptable predetermined perimeters. Is the value of The Decider 450 an even number? If the answer is “Yes”, add one (1) count to ii Countbox 256, then clear the value of Element Countbox 254 to a “0” value. Choose an ii 180 for use in The Chosen One 500 as referenced in steps 626-628. Continue with step 632 and proceed to FIG. 2-C, step 633. If the answer is “No”, add one (1) count to Element Countbox 254 then clear the value of ii Countbox 256 to a 0 value as referenced in steps 629 and 630. In step 631, choose an Element 870 for use in The Chosen One 500. In step 632, proceed to FIG. 2-C, step 633

Turning to FIG. 2-C, an embodiment of the encryption process continues from FIG. 2-B. The value of The Chosen One 500 (either an ii 180 or Element 870) is transferred from either FIG. 2-A, step 618 or from FIG. 2-B, step 632. The value of ii 180 is its ability to look like and act like an actual part of The Message 1000 without being a part of The Message 1000. It is the added smoke needed to conceal and protect the real message, The Message 1000, which is disguised in a cloak of secrecy. In step 633, if Element 870 is The Chosen One 500, then a single Element 870 is pulled from FIG. 2-A step 601. Step 633 will continue to pull a single Element 870 from FIG. 2-A, step 601 until all Elements 870 within Message Box 800 have been used. Continue both processes (with an ii 180 selection or an Element 870 selection) in FIG. 2-C, step 634, by adding a single count to Encryption Count 660 (Countbox 258 within FIG. 2-B).

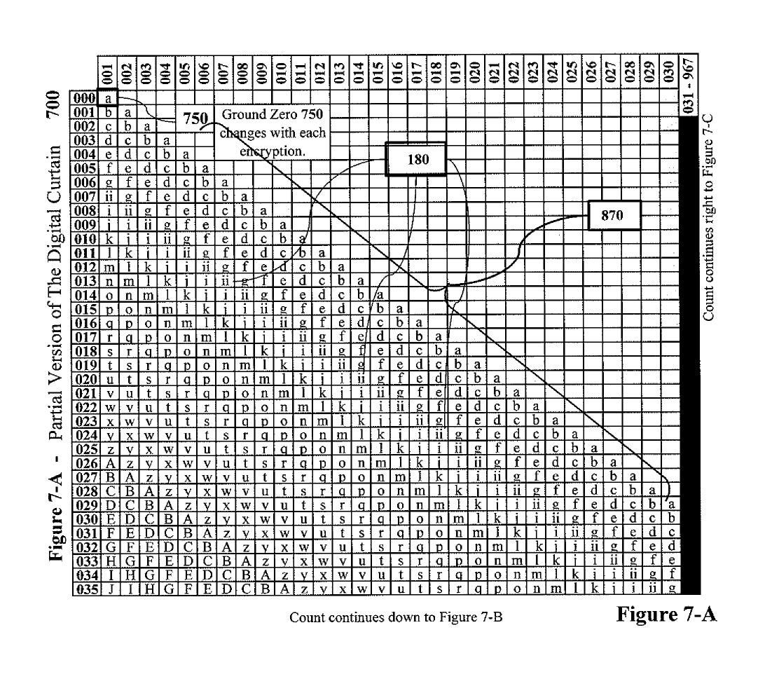

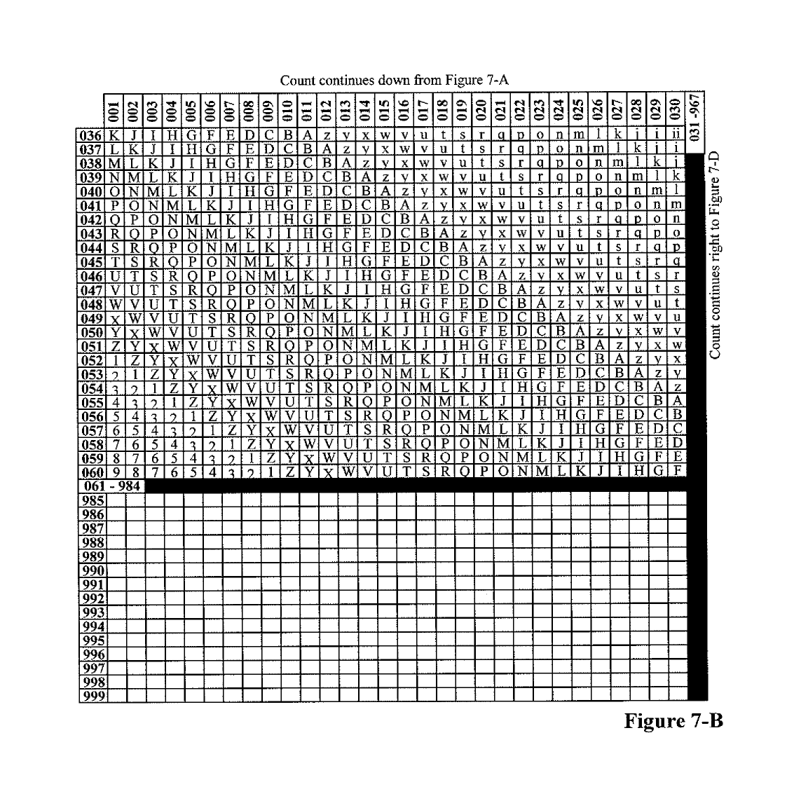

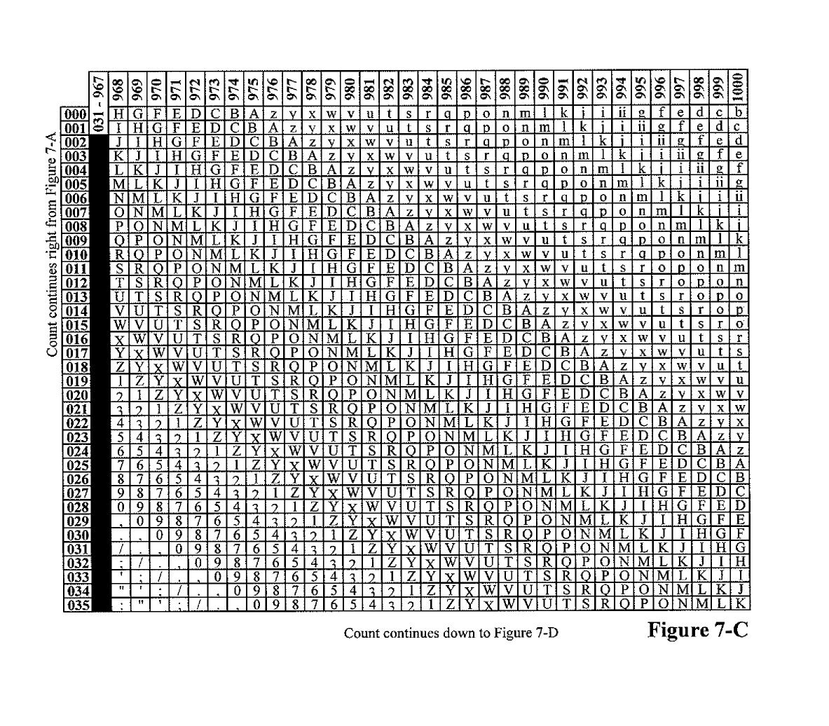

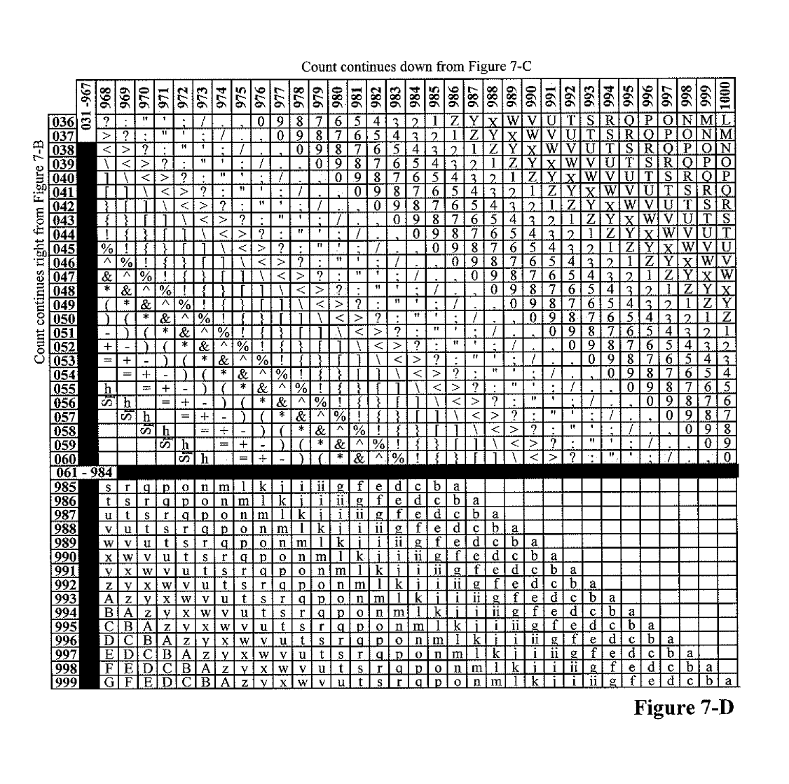

In step 635, question nine establishes if this is the first encryption. If so, it would have been triggered for a one time use by FIG. 2-A step 603. The outcome will determine the column from which the next encryption will be processed. Has this been “triggered” by step 603 in FIG. 2-A? In step 636, if the answer is “Yes”, then in FIGS. 7-a through 7-D, The Digital Curtain 700, do not advance the columns. The numeric value of the Driveshaft 400 is irrelevant. Leave the default column labeled 001 as the column from which the next selection will be made (the next selection will always default to an ii 180). Unlike all encryptions that follow, the first encryption does not advance by the value of Driveshaft 400. For future processing, the Ground Zero 750 coordinate of the column labeled 001 will be assigned a value of “000” until the next encryption. In step 637, if the answer is “No”, in FIGS. 7-A through 7-D, from Ground Zero 750 (coordinates (000, 000) in The Digital Curtain 700; advance the columns by the 3 digit value of Driveshaft 400 (a value with a near-equal distribution between 000-999) as referenced in step 638. Continue.

In FIGS. 7-A through 7-D, an embodiment of The Digital Curtain 700, the coordinates of the previous encryption is now (000, 000) a.k.a. Ground Zero 750. From said Ground Zero 750, the columns are all numbered sequentially to the right of Ground Zero 750 and rows are numbered sequentially below it by a count of “one”. When the “end” (far right column or bottom row) is reached, the count wraps and continues seamlessly. The count of columns wrap from the end right column to the beginning left column and the count of rows continues from the bottom row to the top row. The movement always flows in the same direction, from left to right and top to bottom, in an endless loop. The location of Ground Zero 750 continually changes with each encryption of The Chosen One 500. The Digital Curtain 700 continues to flow as each selected item becomes the new Ground Zero 750 with coordinates (000,000) for the next encryption.

As referenced in step 639 of FIG. 2-C, continue in FIGS. 7-A through 7-D, from the column selected in The Digital Curtain 700, count down the number of rows to the row that corresponds to value represented by The Chosen One 500 (either an ii 180 or Element 870). In step 640 and 641, enter the amount of the count from Ground Zero 750 to the value referenced as The Chosen One 500 as a 3 digit number now known as Encrypted Digits 852 into Encrypted Box 850. Zeros are entered as place holders for single and double digit numbers (7 becomes 007, 1 becomes 001, 0 becomes 000 . . . ).

As stated above, the coordinates of the most recent selection of The Chosen One 500 now becomes Ground Zero 750 with new coordinates (000, 000) for the sequential selection from The Digital Curtain 700. Columns continue to wrap from left to right in sequential count by a “single” count of ones. Rows will continue to wrap from the bottom back to the top sequentially by a “single” count of ones. The count continues seamlessly to form a continuous circle that changes with each encryption. The Encrypted Digits 852 are entered into the Encrypted Box 850 from left to right 3 digits at a time. In FIG. 2-C, step 642, question 10 will establish if this is the very end of the encryption process. Is the value of (ii End Count 664)=0? Refer to FIG. 2-B Countbox 252 for the answer. In step 643, if the answer is “No”, the process repeats at FIG. 2-A, step 606. In step 644-A & B, if the answer is “Yes”, than the 3 digit number “007” is added to the end of Encryption Box 850 to denote the end of the encryption. With the same default value automatically added to the end of every encryption, a quick glance at incoming and outgoing encryptions is one indication if it is the true end of the encryption or if there is a possible interruption in the encryption or transmittal of the message. In steps 645-646, with the completion of the encryption process, Encryption Markers 300-348 are locked onto their corresponding Virtual Wheels 100-148 at the last placement of the Single Digit 160 and its Sequential Number 162 fell on its corresponding Window Box 200-248 at the completion of this encryption process. Clear all count totals from all Countboxes. Clear the value of all formulas to a suspended state. In step 647, the Encrypted Message 1002 is sent to either 1) Computer #2 if this is an exclusive use of the Webcloak or 2) if the Webcloak is set up for processing only with the Central Code Administrator (CCA) 1999, the Encrypted Message 1002 is sent to the CCA 1999, (described below), as determined at inception of the Webcloaks. The encryption process ends.

Example of an Encryption Process

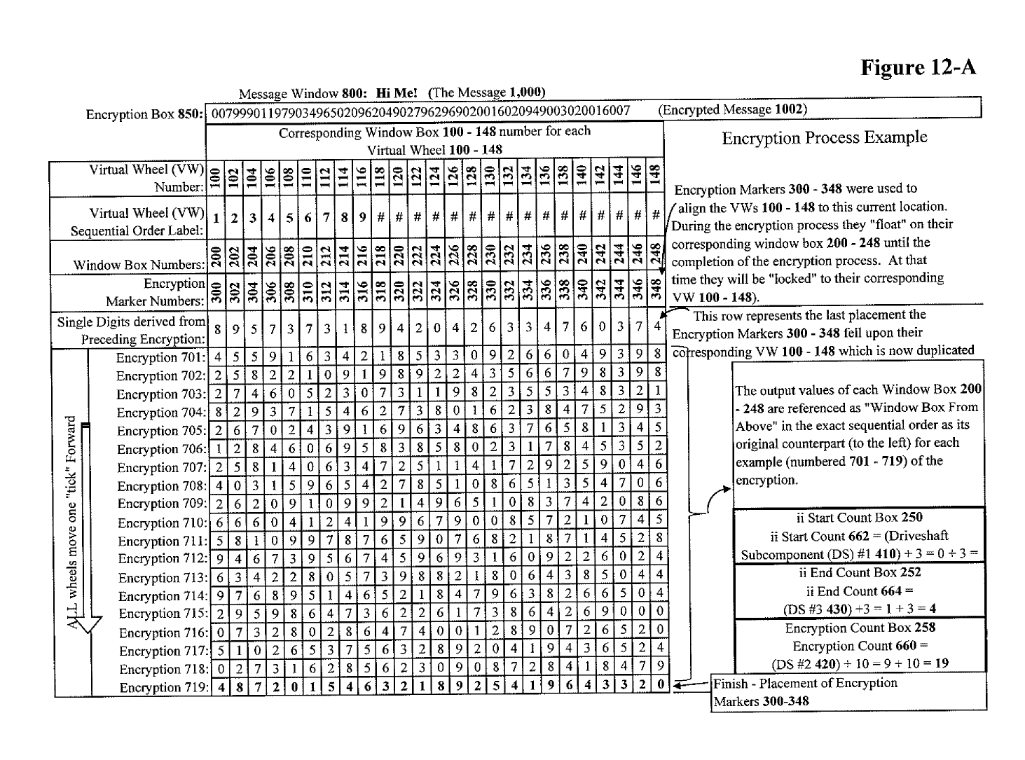

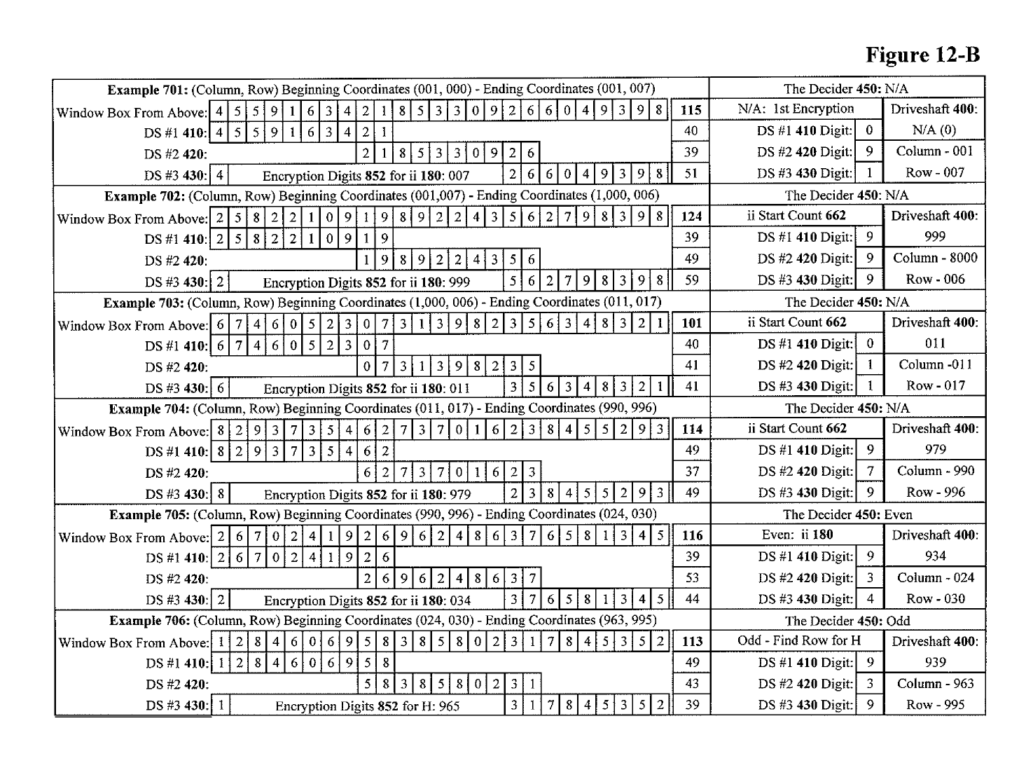

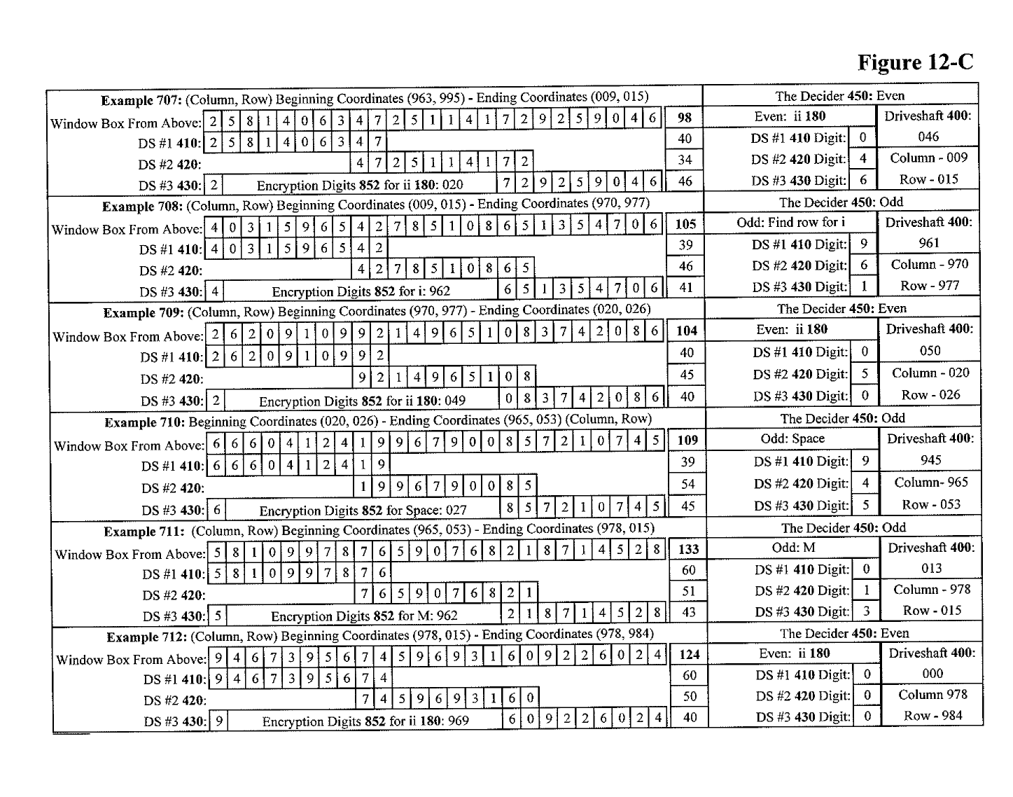

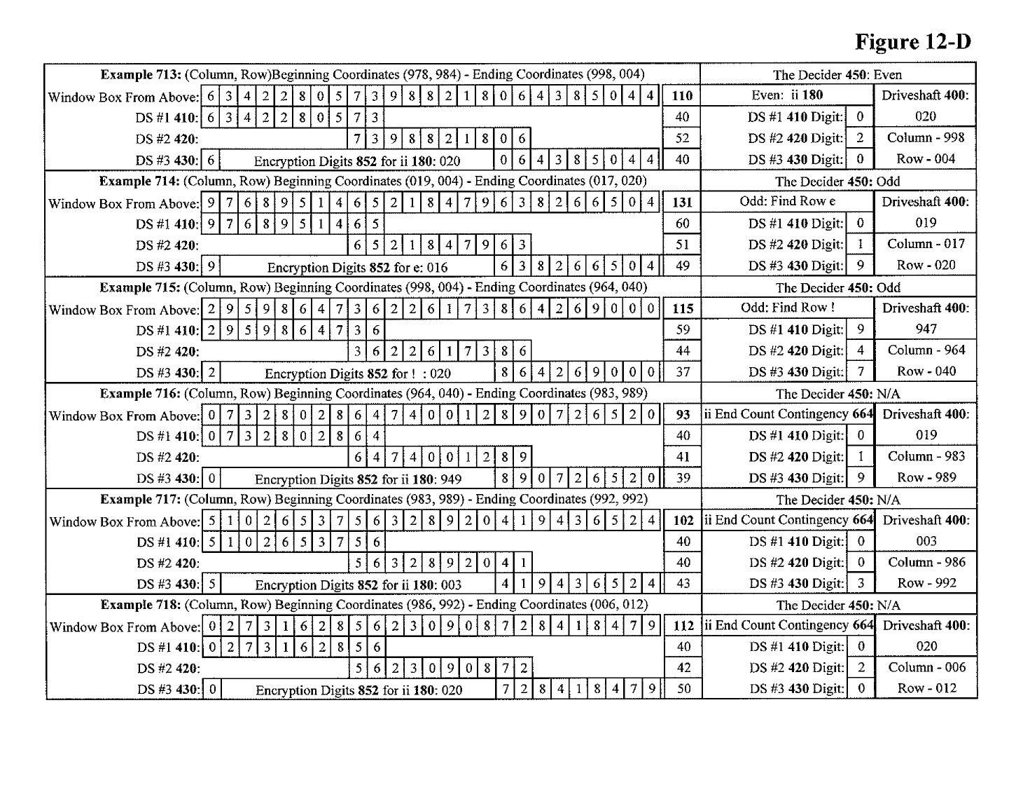

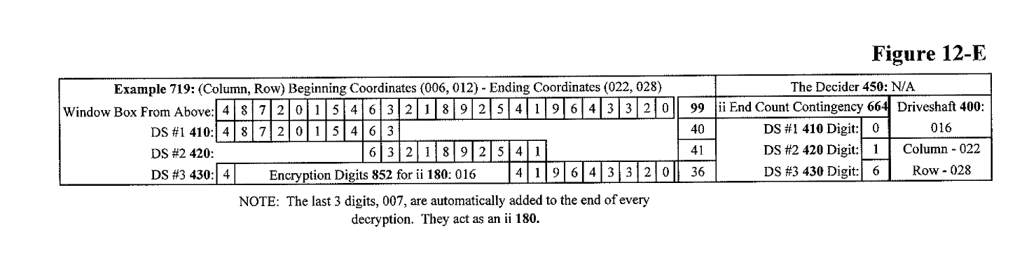

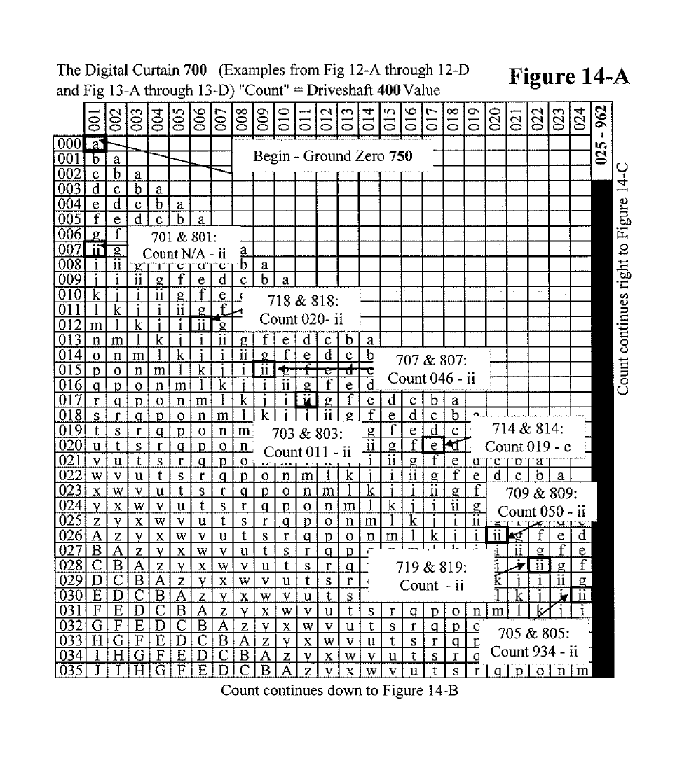

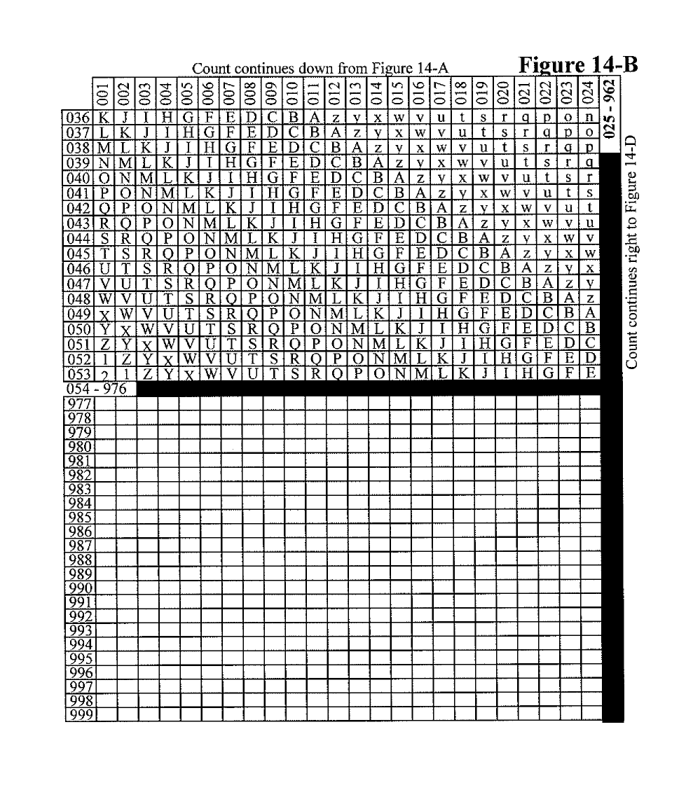

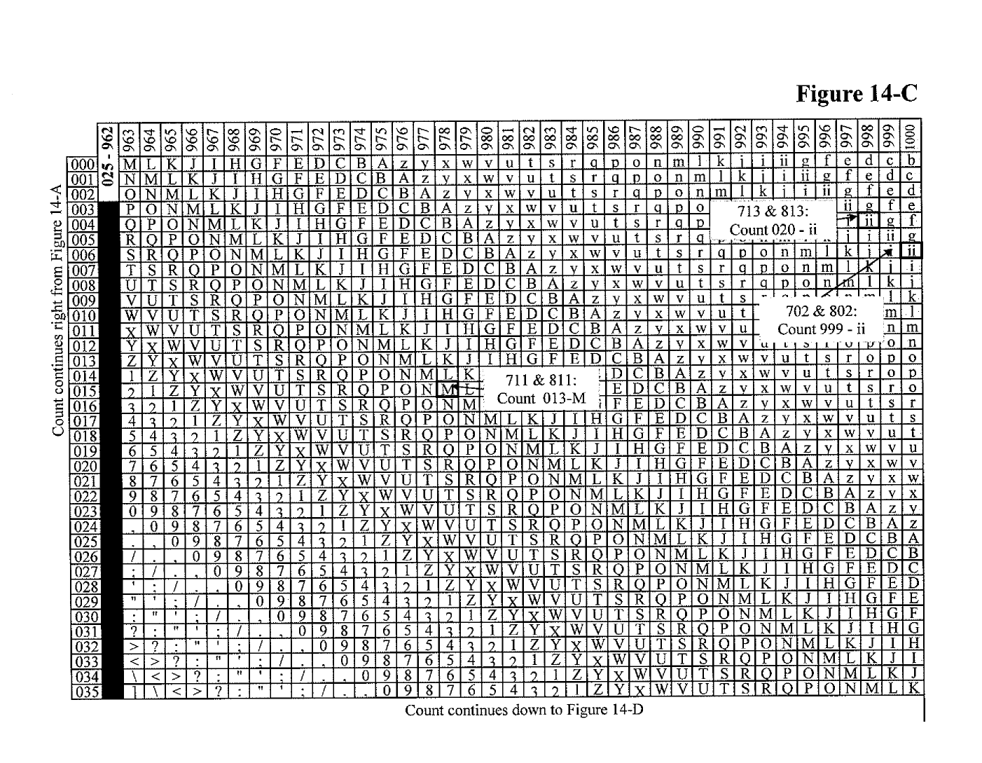

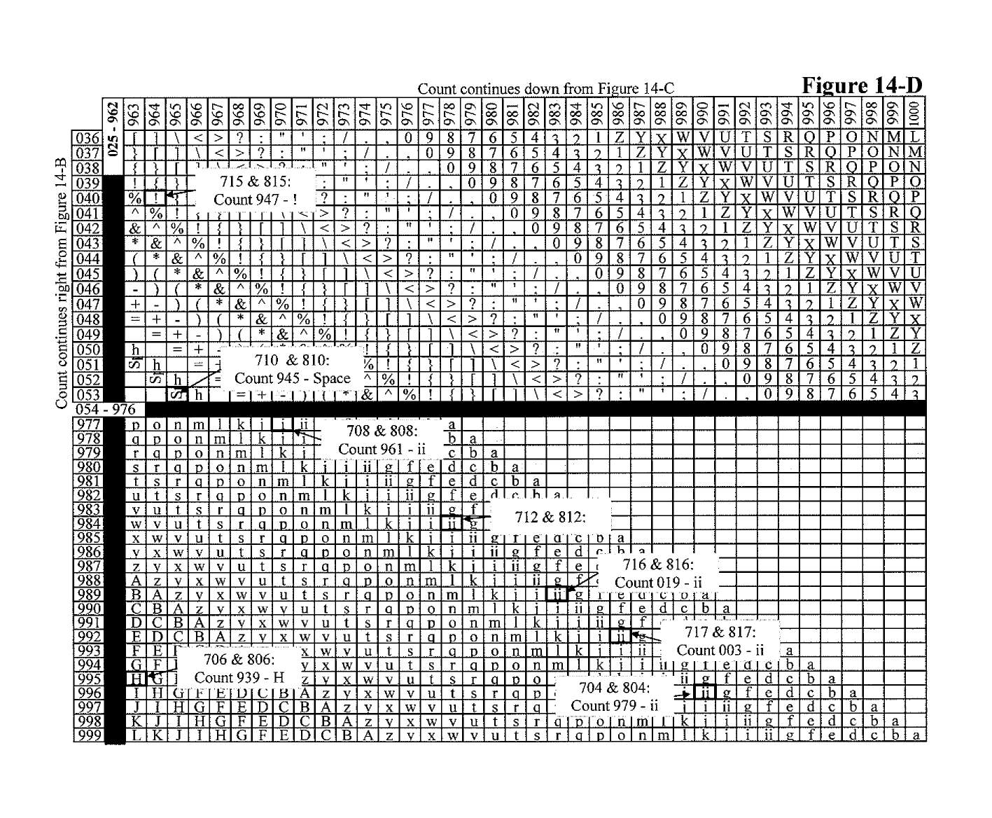

Turning to FIGS. 12-A through 12-E, and FIGS. 14-A through 14-D, an embodiment of a hypothetical example of the encryption process using The Message 1000 “Hi Me!” via the Webcloak and its impact on the Digital Curtain 700 is shown. FIG. 12-A shows the details with respect to each of the Webcloak's Virtual Wheel 100-148. Included in FIGS. 12-A through 12-E are the detail are the Encryption Marker 300-348 numbers and the actual number of the single digit 160 for each encryption referenced in steps 701-719. FIGS. 12-A through 12-E show details with respect to the allocation of each output/Window Box 200-248 and the calculations resulting from that allocation. FIGS. 14-A through 14-D show the results of the Driveshaft 400 and its impact on the Digital Curtain 700.

Decryption Process

Turning to FIG. 3A, an embodiment of the decryption process is shown. The decryption process is fundamentally a similar process to the encryption process, yet with a few notable differences: 1) the Decider 450 is not utilized 2) there are no contingency questions 3) there are no Countboxes 4) the decryption is processed 3 digits at a time. All 3-digit numbers are deciphered into their original state, either ii 180 or Element 870. However, only Elements 870 (the items from the original message, The Message 1000) are transferred into the final Decrypted Box 900. The deciphered ii 180 essentially “evaporates” into the nothing it was born from (e.g., discarded).

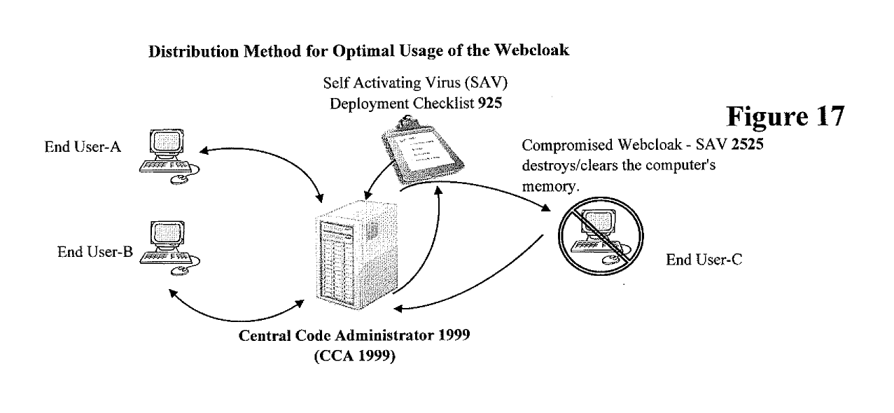

In step 501, the decryption process begins when, in the first instance, End User-B receives the encrypted message directly from computer #1 if this is an exclusive use Webcloak configuration between only those two computers. If the original message was sent to the Central Code Administrator 1999 (CCA 1999), than the encrypted message from computer #1 would have been decrypted by the CCA 1999 using the Webcloak configuration End User-A used to send the message. As End User-B logs onto the CCA 1999, the CCA 1999 recognizes End-User-B and the Webcloak configuration contained on the computer/portable device End User-B is using to log on to the CCA 1999. Additional detail with respect to the processing of the CCA 1999 is discussed within the description of FIGS. 15-A through 15-B and FIG. 17.

The following process assumes the sending of an Encrypted Message 1002 from End User-A directly to a computer with the same Webcloak configuration of End User-B, with said message now known as Encrypted Message Received 1004.

In step 501, the decryption process begins when the Encrypted Message Received 1004 is received into Received Encryption Box 890 in the form of a string of numbers. The Encrypted Message Received 1004 will be decrypted with the exact same Webcloak (the same “recipe”) as the Webcloak End User-A used to send the message. The order in which Received Encrypted Message 1004 is decrypted will be from left to right, top to bottom, three digits (Encrypted Digits 852) at a time and only when triggered. In step 502 and within the Googol Production Engine 99 (GPA 99), all 25 Decryption Markers 350-398 are aligned with their corresponding Window Boxes 200-248 so as to adjust all Single Digits 160 and Sequential Numbers 162 along their corresponding Virtual Wheel 100-148 at the exact placement at the completion of the last decryption. The Decryption Markers 350-398 are “unlocked” from their current position and align themselves with the Window Box 200-248 until the decryption process is complete.

Step 503 process a trigger for the first question, question #11 (refer to FIG. 3-B, step 508), for a one-time response of “Yes”. The default is “no” for all other decryptions that follow. This ensures that the 1^{st} decryption is processed in a different manor then the following decryptions.

Step 504 is the first step of all repeats. “Tick”—All Virtual Wheels 100-148 turn one “tick” resulting in the advancement of all Single Digits 160 and their corresponding Sequential Number 162 to advance one digit through their corresponding Window Boxes 200-248 (always in the same direction and always in sequential order). Said Window Boxes 200-248 remain fixed in place as the Virtual Wheels 100-148 advance. In the process, all Window Boxes 200-248 are repopulated with the value of a new Single Digit 160. The Decryption Markers 350-398 aligned with said Window Boxes 200-248 and remain aligned with their corresponding Window Box 200-248 until the decryption process is complete. The results of the “tick” and subsequent change in the value of all Window Boxes 200-248 are as follows:

The values of Driveshaft Subcomponent (DS) #1 410, DS #2 420 and DS #3 430 are created using the populated results of the “tick” of all Virtual Wheels (100-148).

FIG. 11 provides a high level overview of the encryption and decryption embodiments discussed above with reference to FIGS. 2-A through 3-B.

Turning to FIG. 4, FIG. 6 and FIG. 8, Example #1, an embodiment of the allocation of the value of all Window Boxes 200-248 via the DS Assignment Number 440 is shown. The value of DS #1 410 is the last digit of the sum of Window Boxes 200-218 (10 boxes total). The actual sum is a range in value from “0” through 90. Only the last digit of the sum becomes DS #1 410). This single digit, DS #1 410, has only one use in the decryption of messages. DS #1 410 is the first number of Driveshaft 400.

The value of DS #2 420 is the last digit of the sum of Window Boxes 218-236 (10 boxes total). This single number, DS #2 420, has only one use in the decryption process. DS #2 420 is the second digit of Driveshaft 400.

The value of DS #3 430 is the last digit of the sum of Window Boxes 234-248 and Window Box 200 (10 boxes total). This single digit, DS #3 430, has one use in the decryption process. DS #3 is the last (3^{rd}) number of Driveshaft 400.

Driveshaft 400 is created by stringing the three single-digit numeric values of DS #1 410, DS #2 420 and DS #3 430 together to form one three digit number, the Driveshaft 400. The Driveshaft 400 is always a 3 digit number with a value ranging from “000” through “999” with a near-equal distribution of all numeric possibilities. Driveshaft 400 is used for the advancement of the Digital Curtain 700. Continue.

In step 505-506, the first three Encrypted Digits 852 are removed from Received Message 890 from left to right, 3 digits at a time. The Encrypted Digits 852 are advanced to FIG. 3-B, step 507. Continue with FIG. 3-B, step 507.

Turning to FIG. 3-B, an embodiment of the decryption process which continues from FIG. 3-A is shown. In step 507, the Encrypted Digits 862 are transferred in from FIG. 3-A, step 506. In step 508, question eleven establishes if this is the initial decryption and would have been triggered in FIG. 3-A, step 503. Is this the first decryption of received Encryption 890? In step 509, if the answer is “Yes”, proceed to FIGS. 7-A through 7-D, The Digital Curtain 700. Do not advance the columns in The Digital Curtain 700. NOTE: The outcome decryption of the first 3 digits will always be an ii. Continue with step 512. In steps 510-511, if the answer is “No”, proceed to FIGS. 7-A through 7-D, The Digital Curtain 700 and from Ground Zero 750, the location of the last decipherment, advance the columns by the value of Driveshaft 400 using the column containing Ground Zero 750 as beginning column with a value of 000 and sequentially numbering all columns to the right (continuously wrap from the end right to the beginning left with a continuous count).

The most recent decryption selection is now known as Ground Zero 750 for this decryption of Encrypted Digits 852. Thus, the coordinates of the previous decryption becomes (000, 000) a.k.a. Ground Zero 750. The columns are all numbered sequentially to the right of Ground Zero 750 and rows are numbered sequentially below it by a count of “one” and beginning with one (1). When the end (far right or the bottom) is reached, the count continues seamlessly from the far right column to the first left column and from the bottom row seamlessly to the top row. The movement always flows in the same direction, from left to right and top to bottom, in an endless loop. Ground Zero 750 continually changes with each decryption of Encrypted Digits 852. The Digital Curtain 700 continues to flow as each selected item becomes the new Ground Zero 750 with coordinates (000,000) for the next decryption.

In step 512-513, (continued from above) from the column selected in The Digital Curtain 700 within FIGS. 7-A through 7-D, count down the rows from Ground Zero 750 by the amount of the Encrypted Digits 852 using the value of the row of Ground Zero 750 as 000. If the bottom is reached, continue the count from the top in the same columns and in a continuous wrap. Transfer the value of the box selected (ii, letter, number, et al) out. Mark the current box as “Ground Zero 750” with a coordinate value of (000, 000) for the next decryption.

In step 514, question twelve determines if the value of the selected item should be transferred to Decrypted Box 900. “Is the item selected an ii 180? ” If “Yes”, no value is transferred into Decrypted Box 900 and ii 180 evaporates into the nothing it was born from as in step 517. In step 515, if the answer is “No”, transfer the element (letter, number, space, symbol, et al) into Decrypted Box 900 from left to right. The Decrypted Box 900 accepts the item. Continue.

In step 518, question thirteen is looking for the end of the decryption. Does Received Encryption Box 890 contain only 3 digits? In step 519, if the answer is “No”, then repeat . . . continue the process with FIG. 3-A, step 504 “Tick”. In step 520, if the answer is “Yes”, Decryption Markers 350-398 are aligned and locked onto their corresponding Virtual Wheel 100-148 at the last placement of the Single Digit 160 and Sequential Number 162 that had fallen upon its corresponding Window Boxes 200-248 during this decryption process. The computer's memory/detachable device containing the Webcloak is updated with this new location. In steps 521-522, the Received Message 1004 has been deciphered into Decrypted Message 1010. The Decrypted Message 1010 is displayed in Decrypted Box 900 using a visual output, the computer display 152. The decryption process ends.

Example of the Decryption Process

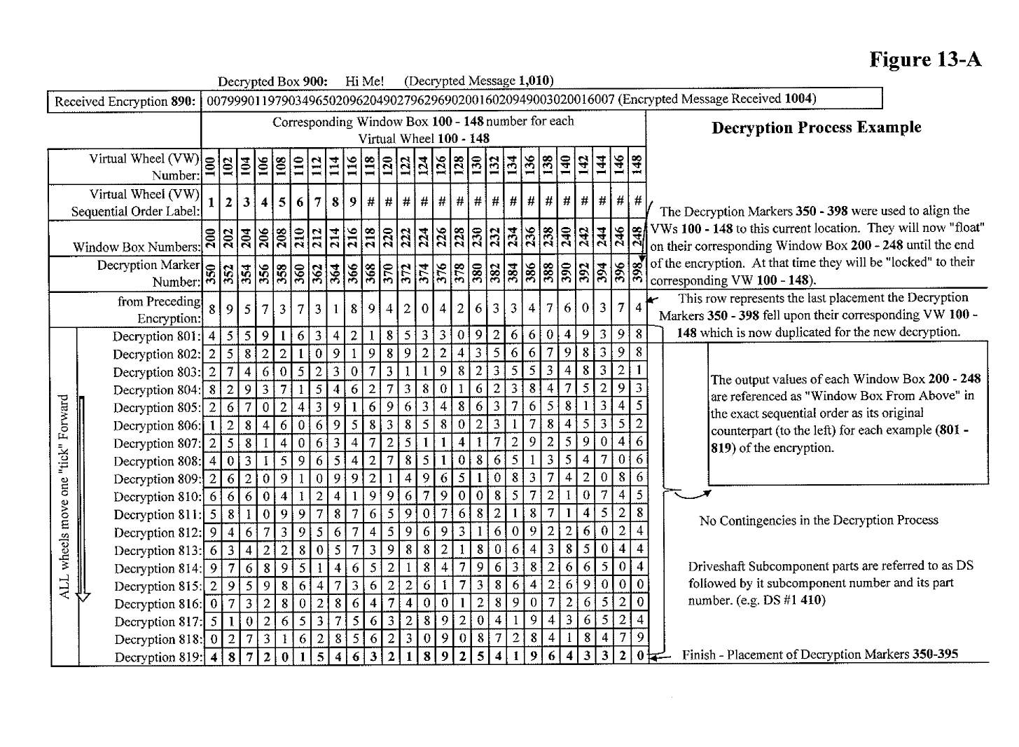

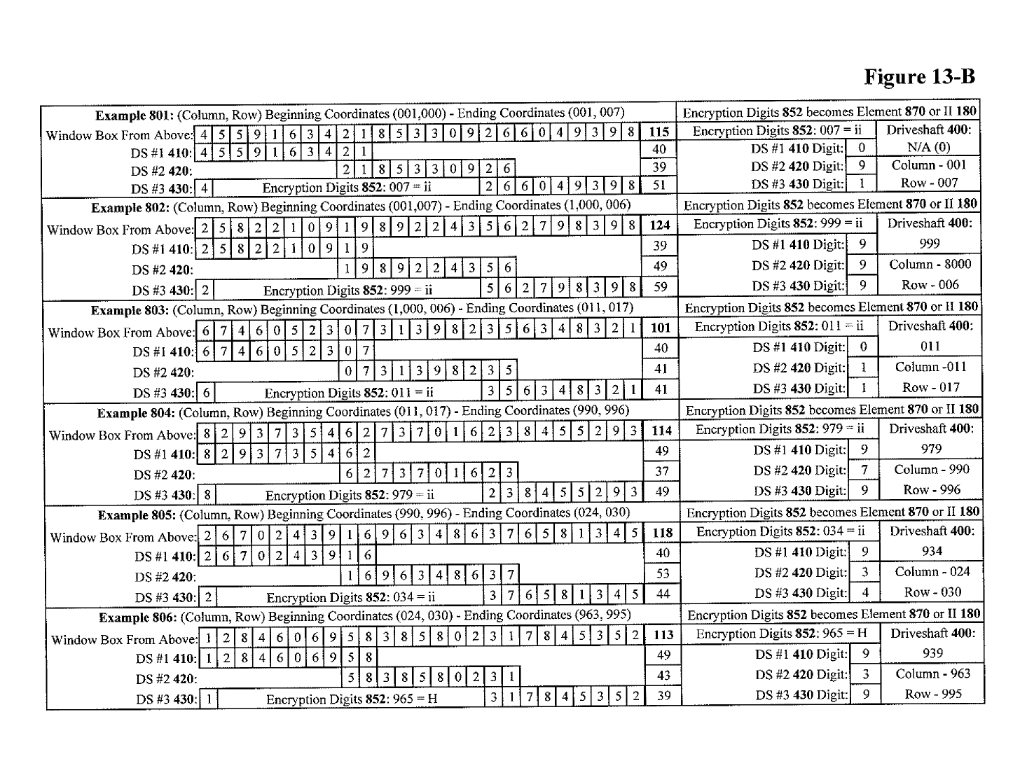

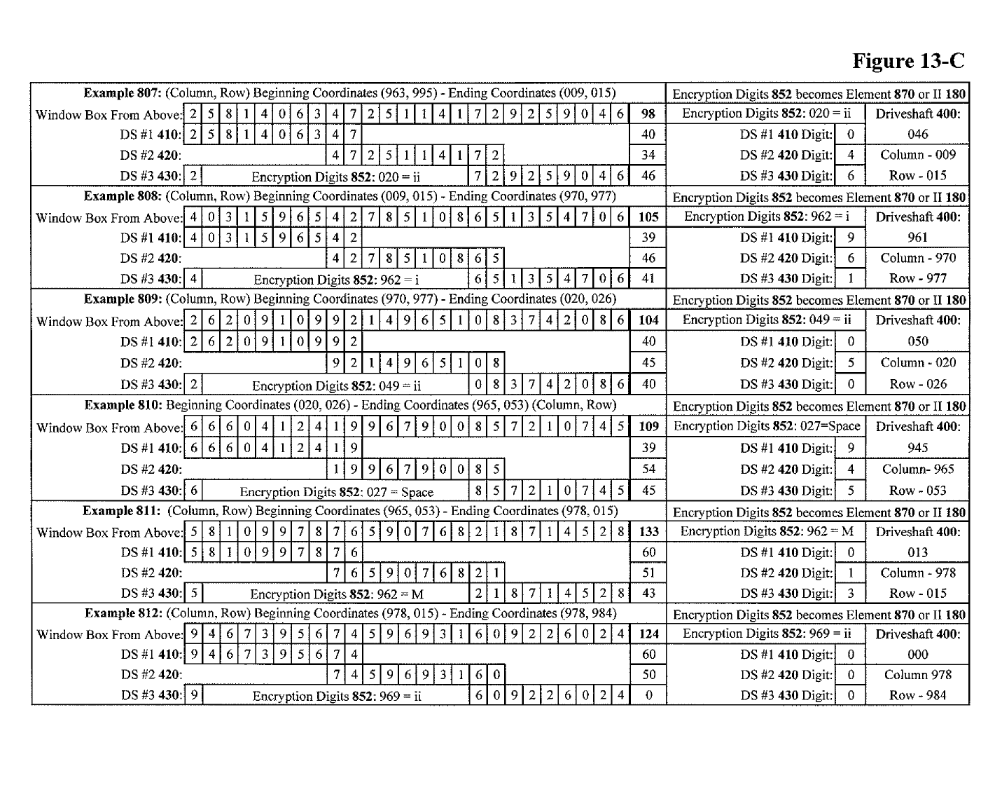

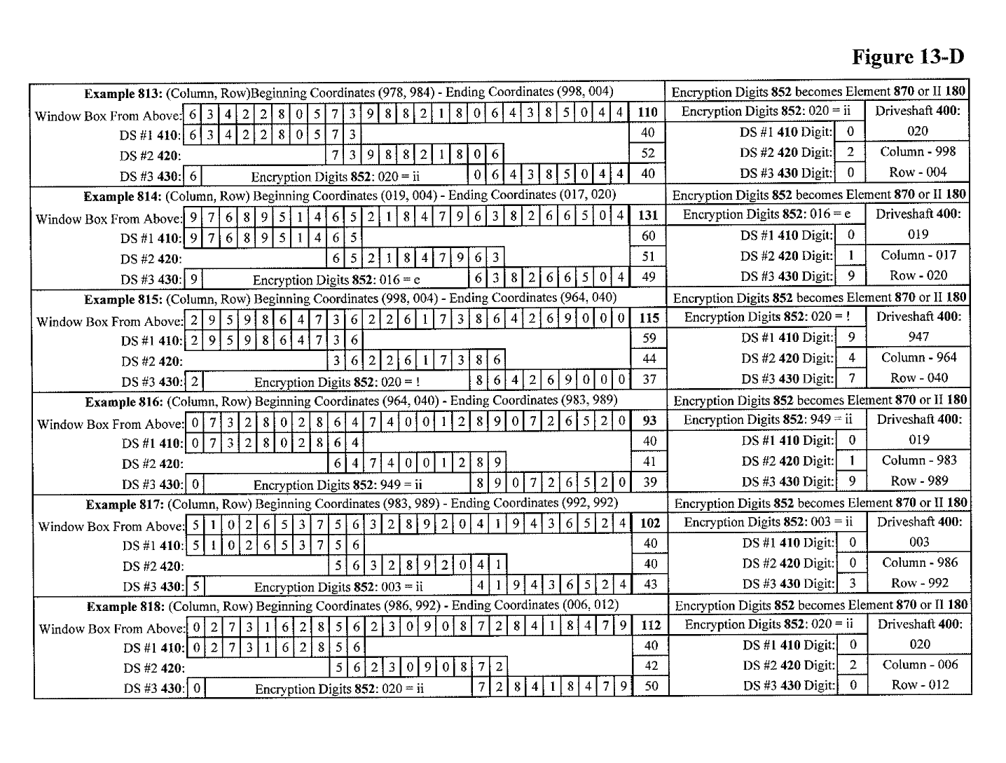

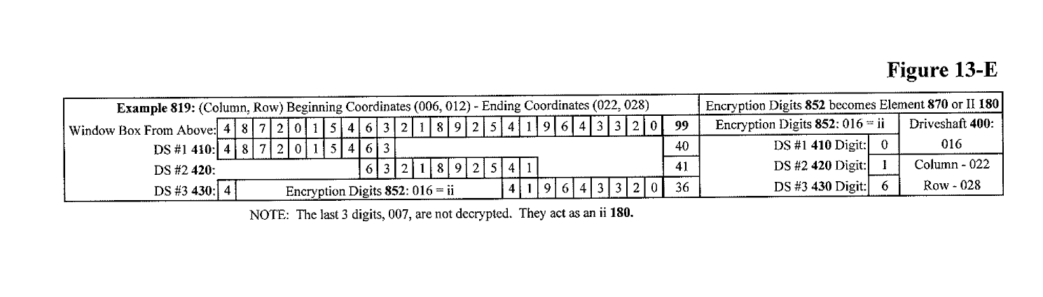

Turning to FIGS. 13-A through 13-E, and FIGS. 14-A through 14-D, an embodiment of a hypothetical example of the decryption process of the Encrypted Message 1002: 007999011979034965020962049027962969020016020949003020016007 via the Webcloak and its impact on the Digital Curtain 700 is shown. FIG. 13-A shows the details on each of the Webcloak's Virtual Wheel 100-148. Included in the detail are the Decryption Marker 350-398 numbers and the actual number of the single digit 160 for each decryption 801-819. FIGS. 13-A through 13-E show details of each step of the decryption process from 801 through 819 as well as the allocation of each output/Window Box 200-248 and the Driveshaft 400 calculations resulting from that allocation. FIGS. 14-A through 14-D show how the results of the Webcloak impact the Digital Curtain 700.

Turning to FIG. 20, an embodiment of a multitude of Digital Curtain 700 with one Ground Zero 750 is shown. In this example, each Digital Curtain 700 is comprised of a set of 500 rows and 500 columns. The Digital Curtain 700 continues to work the same with Ground Zero 750 continually advancing from the left to the right by the value of the Driveshaft 400. During the encryption process, a downward count is done to the exact location of the item to be encrypted. When the bottom row is reached, the count continues either to the next Digital Curtain 700 found below it or, if the Digital Curtain 700 is already on the bottom, the count continues from the top row of the same column. The same is for the count of columns. If the most right column is reached and there is another Digital Curtain 700 to the right, the count continues to the next Digital Curtain 700. However, if the Digital Curtain 700 is already at the end right, then the count of columns wraps to the furthest left column while remaining in the same row. The process continues until the bottom most Digital Curtains 700 are reached.

In this example, when a count of rows is being processed and the bottom row of the three Digital Curtain 700 located along row R-11 is reached, the count continues from the top left Digital Curtains 700. More specifically, when the bottom row is reached in the Digital Curtain 700 in Row R-11, Column C-I, C-J and C-K, the wrap continues in row R-1, columns C-A, C-B and C-C while maintaining the same number of columns away from the furthest left column within either row.

The same is true during the count of columns. If the furthest left column is reached in the four Digital Curtain 700 that fall into column C-K, the wrap of columns begins in column C-A. More specifically, when the furthest right column is reached in the Digital Curtains 700 located in column C-K, rows R-8, R-9, R-10 and R-11, the wrap of columns continues with column C-1 in rows R-1, R-2, R-3 and R-4 with the same number of rows away from the upper most row within either column.

In this example of The Sash and The Bug 751, each Digital Curtain 700 contains 250,000 boxes. With the 63 Digital Curtain 700 shown, there are 15,750,000 boxes with each Element 870 or ii 180 occurring 31,500 within The Sash and The Bug 751.

The Sash and The Bug 751 differs from the traditional single Digital Curtain 700. In this example, the majority of the 3-digit value will be a value between 000-500 yet each item (Element 870 or ii 180) is represented 31,500 times.

Central Code Administrator

In one embodiment, all correspondents and messages are safely held within the confines of the Central Code Administrator 1999 (CCA 1999, FIG. 17) with the CCA 1999 comprising a server, a memory, a processor and password protection. The CCA 1999 keeps continuous and accurate records of every Webcloak using a unique ID number so as to identify and duplicate the exact Webcloak configuration used by an end user. Since the CCA 1999 contains all past and present Webcloak parts, it can easily pull up and reconfigure the end user's Webcloak. The CCA 1999 and end user's Webcloaks are continually in synchronization with each other. After decryption, the CCA 1999 updates and saves all Webcloak information. The CCA 1999 either sends the message to the recipients if they are logged onto the CCA 1999 or it saves the message and then send the message as all intended end users log into the CCA 1999 from a computer with a Webcloak or a computer with a detachable device containing a Webcloak. Once the intended end user logs into the CCA 1999, the original message will be encrypted to the Webcloak from said intended end user at which time the intended end user can choose whether or not to reply to the Decrypted Message 1010.

Turning to FIG. 15-A, an embodiment of a process performed by the Central Code Administrator 1999 in the facilitating of the encryption and decryption of end user messages as well as the management of all The Message 1000 is as shown. In steps 1501-1504, End User-A (or End User-C) enters the logon information from a computer or detachable device containing a Webcloak using a keyboard 154 or any other method of inputting data. Refer to the encryption process referenced in FIGS. 2-A and 2-B that show the details of how a message is encrypted using a Webcloak. End User-A's (or End User-C's) Webcloak encrypts the login information using the saved location of the Encryption Markers 300-348 to properly position all Window Boxes 200-248 along their corresponding Virtual Wheel 100-148 (VW 100-148). The Webcloak's ID number is sent with the encryption to the Central Code Administrator 1999 (CCA 1999). The CCA 1999 receives the Webcloak ID # as well as the encrypted login information. The CCA 1999 accesses the Webcloak's configuration and any additional information within its ID number.

In step 1505, see the embodiment of FIG. 17 for the following: Question fourteen checks for a Webcloak contained on a lost or stolen computer or detachable device. “Does the Webcloak belong to a compromised system?” The CCA 1999 compares all incoming Webcloak ID numbers to the Self Activating Virus (SAV) Deployment List 925 which contains a list of the Webcloak ID numbers for all known compromised systems. If the incoming encrypted message comes from a compromised Webcloak, than the response is “yes” and the Self Activating Virus (SAV) 2525 is deployed, as referenced in step 1516. In steps 1517 and 1518, The CCA 1999 deploys the SAV 2525 which is either 1) housed within the Webcloak now in the hands of an End User-C or 2) sent from the CCA 1999 to the computer or detachable device. The SAV 2525 destroys all computer memory and programs as well as the Webcloak. The login process is abruptly terminated (see FIG. 17, End User-C example). If the answer to question 14 is “No”, continue.

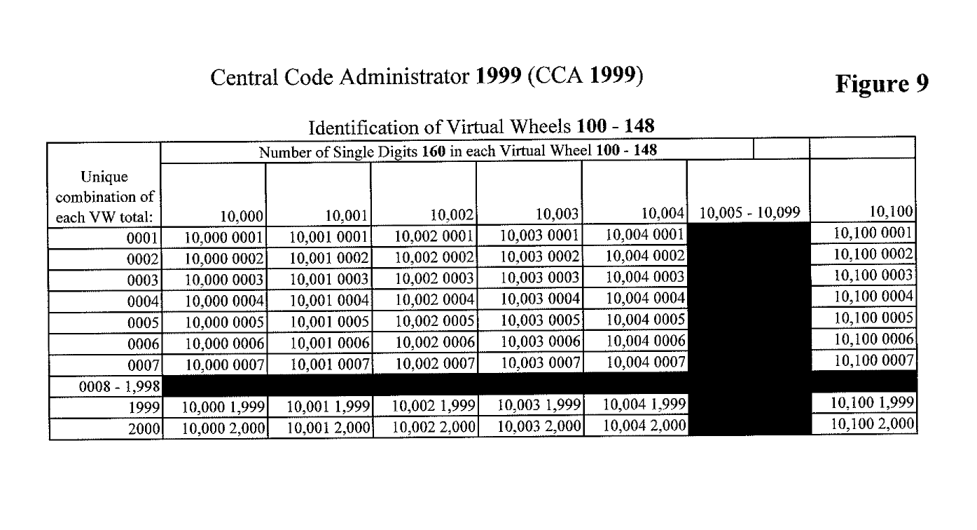

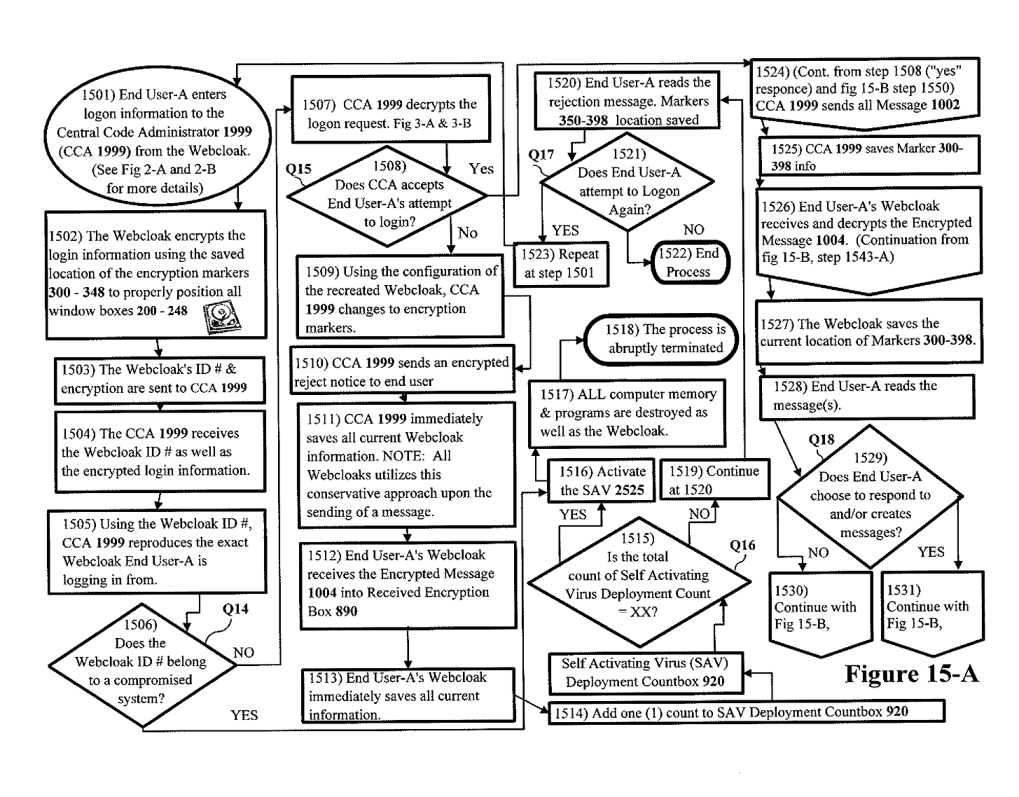

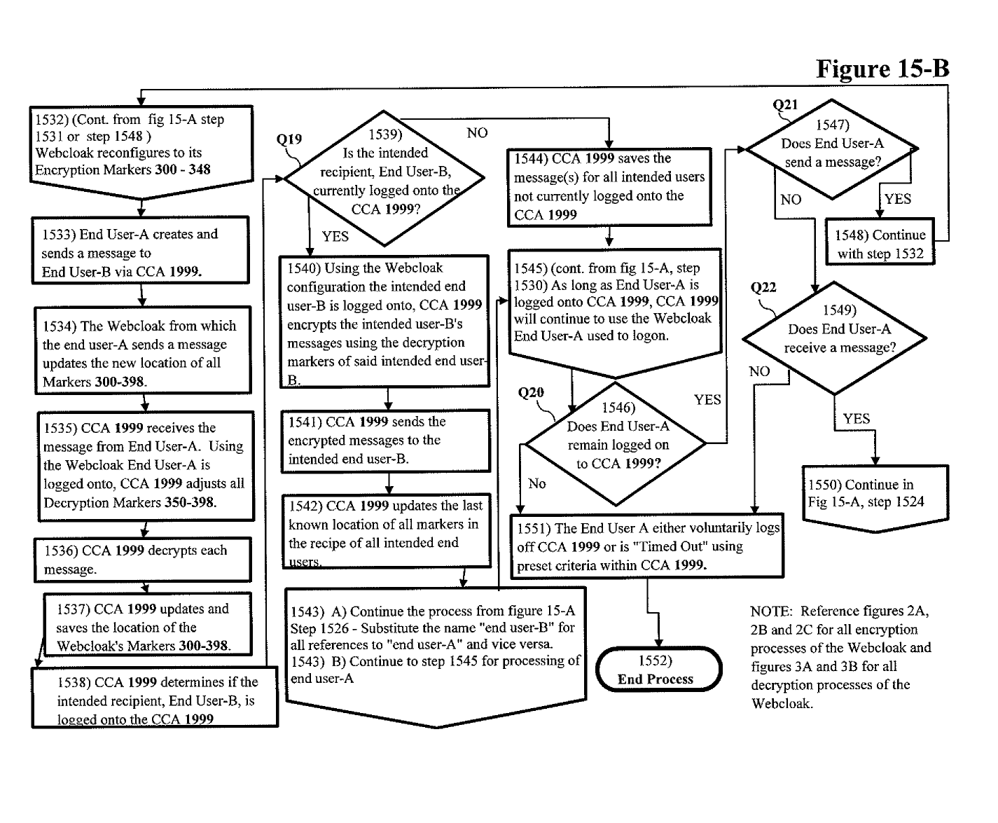

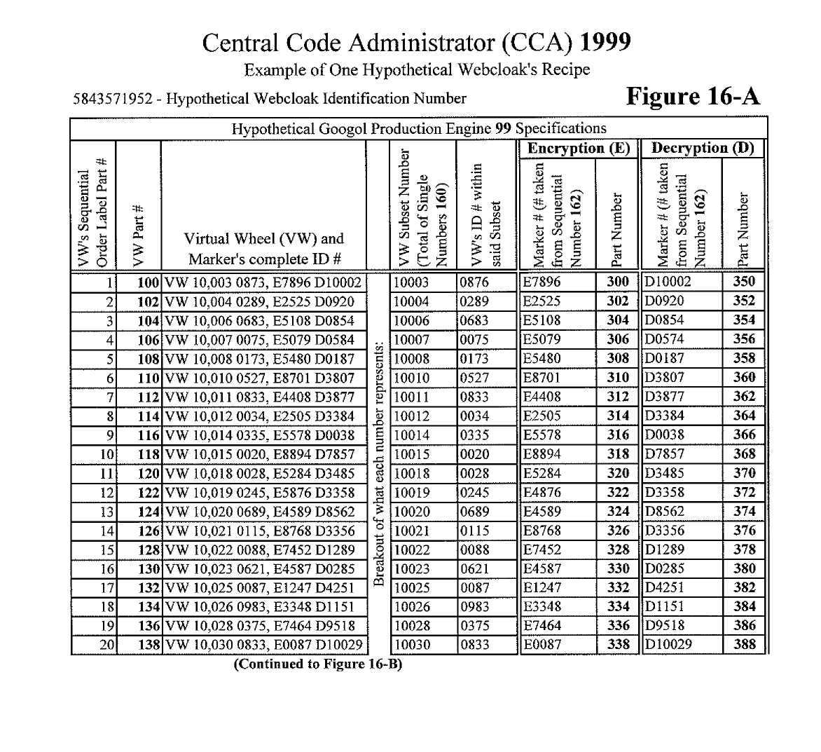

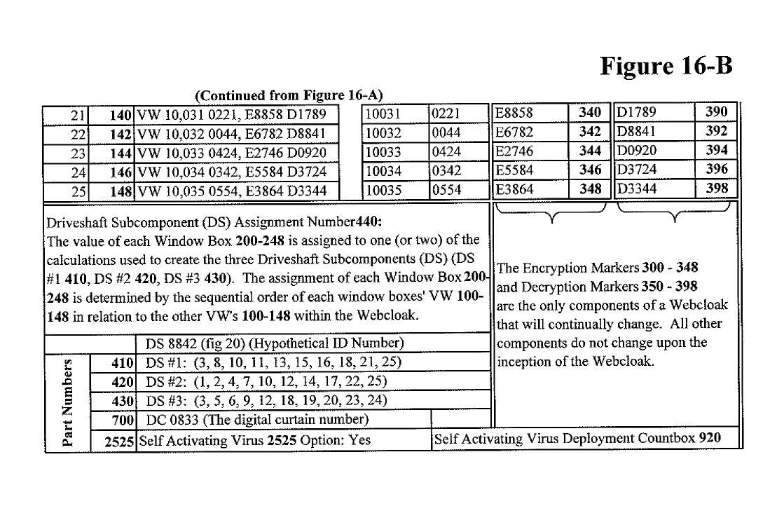

In step 1507, using the Webcloak ID #, The CCA 1999 reproduces the exact Webcloak End User-A is attempting to log in from. The Webcloak is re-created to the exact specification of the Webcloak found on the computer/detachable device that sent the message. See FIGS. 6 and 16 for an example of the embodiment that is contained within a Webcloak's recipe. See FIGS. 8 and 9 for hypothetical examples of the embodiments that might be held by the CCA 1999. The Webcloak recreated by the CCA 1999 adjusts the position of all Window Boxes 200-248 to align with the Decryption Markers, 350-398; CCA 1999 decrypts the logon request. Refer to FIGS. 3-A and 3-B for the decryption process.

In step 1508, question fifteen continues the process. Does the CCA 1999 accept End User-A's attempt to login? If the answer is “No”, then the CCA 1999 saves the location of the Decryption Markers 350-398 then adjusts all Window Boxes 200-248 from the location of the Decryption Markers 350-398 to Encryption Markers 300-348. The CCA 1999 sends an encrypted reject notice to end user. (refer to the encryption process, FIGS. 2-A, 2-B and 2-C) The CCA 1999 immediately updates and saves all current Webcloak information identified by the Webcloak's ID # as referenced in steps 1509-1511. If the answer is “Yes”, continue to step 1524.

Preferably, the system utilizes a conservative approach by assuming that any sending or receiving of messages will be the last. Thus, the CCA 1999 is continuously updating the Webcloak's recipe with the most recent Marker 300-398 locations. The same continuous updating is done on all Webcloaks contained within all computers or detachable devices. In step 1512, the End User-A's Webcloak receives the Encrypted Message 1004 into its Received Encryption Box 890. End User-A's Webcloak immediately saves the location of the Decryption Markers 350-398 referenced in step 1513. All Window Boxes 100-148 are realigned from Encryption Markers 300-348 to the location of the Decryption Markers 350-398. The Encrypted Message Received 1004 is decrypted. The End User-A's Webcloak immediately saves all current information. In step 1514, a count is added to End User-A's “Self Activating Virus (SAV) Deployment Countbox 920.”

In step 1515, question 16 is looking for a prompt to deploy the SAV 2525 in the event an eavesdropper is attempting numerous login attempts in hopes of getting it right. Is the total count of Self Activating Virus Deployment Count 920 =XX? The XX equals a preset value, from 2 to 10,000+ with the preset value determined prior to the creation of the Webcloak. A quick check of the value of the SAV Deployment Countbox 920 is done to obtain the answer. In step 1516-1518, if “Yes”, than the SAV 2525 is deployed. The memory contents of a computer from which End User-A is signing on from are destroyed, including the Webcloak information. The process is abruptly terminated. In steps 1519-1520, if the answer is “No” than End User-A receives and reads the rejection message sent by the CCA 1999.

In step 1521, question seventeen looks to continue the process. Does End User-A attempt to Logon Again? If End User-A chooses not to continue the login process, the process ends in step 1522. The Webcloak saves the new Webcloak information; the new placement of all markers 300-398 upon the Webcloak. In step 1523, if the End User-A chooses to attempt to login again, the process is repeated from step 1501.

Within step 1524: 1) a “yes” response to question 15 in the same FIG. 2-A step 1508 prompts the End User-A to this step. 2) In FIG. 15-B, step 1550 prompts the flow to this step)—Now that End-User-A has successfully signed in to the CCA 1999 or continues to be signed on to the CCA 1999, the CCA 1999 makes a direct association between the Webcloak ID# and End User-A for the remainder of End User-A's log onto the CCA 1999. Using End User-A's Webcloak specifications, the CCA 1999 encrypts all (if any) The Message 1000 held within the CCA 1999 intended for End User-A. The CCA 1999 send the Encrypted Message 1002 to the Webcloak located on the computer or detachable device of End User-A. The CCA 1999 saves the last known location of all Encryption Markers 300-348 in the recipe (preferably utilizing a conservative approach assuming the end user will not respond) as referenced in step 1525.

Repeat from FIG. 15-B step 1543-A. Step 1526 - End User-A's Webcloak receives Encrypted Messages Received 1004 in the Received Encryption Box 890. The Webcloak decrypts said message (see FIGS. 3-A and 3-B for the decryption process) then saves the current Decryption Markers 350-398 settings. The Webcloak displays any and all Decrypted Message 1010 in the Decrypted Box 900. End User-A reads Decrypted Message 1010 as referenced in steps 1527 and 1528.

In step 1529, question eighteen is looking for End User-A's response. Does End User-A chooses to respond to message(s) and/or creates a message(s)? If the answer is “No”, the process continues with FIG. 15-B step 1545 as referenced in step 1530. In step 1531, if “Yes”, the process continues with FIG. 15-B step 1532.

Turning to FIG. 15-B, a further embodiment of a process performed by the Central Code Administrator 1999 in the facilitating of the encryption and decryption of end user messages as well as the management of all The Message 1000 is shown. FIG. 15-B is a continuation of the process from FIG. 15-A. In step 1532, The Webcloak found on said computer or detachable device reconfigures the location of all Window Boxes 200-248 within each Virtual Wheel 100-148 from the location of its Decryption Markers 350-398 to Encryption Markers 300-348. The most resent location of all Decryption Markers 350-398 is saved.

In steps 1533-1534, End User-A creates and sends a The Message 1000 to End User-B via the CCA 1999. Refer to FIGS. 2-A, 2-B and 2-C for the encryption processing of the Webcloak. The Webcloak from which the End User-A sent Encrypted Message 1002 updates the new location of all Encryption Markers 300-348. In steps 1535-1538, CCA 1999 receives the Encrypted Message Received 1004 from End User-A. Using the Webcloak End User-A is logged onto; the CCA 1999 adjusts all Decryption Markers 350-398 to the decryption process. The CCA 1999 decrypts each Encrypted Message Received 1004 received, as it is received into Decrypted Message 1010. The CCA 1999 updates and saves the current Webcloak information with each decryption. The CCA 1999 determines if the intended recipient, End User-B, is logged onto the CCA 1999.

In step 1539, question nineteen determines what to do with the decrypted message. Is the intended recipient, End User-B, currently logged onto the CCA 1999? In step 1544, if the answer is “No”, the CCA 1999 saves The Message 1000 for intended End User-B who is currently not logged into the CCA 1999 and the process continues with step 1545. In step 1540-1542, if the answer is “Yes”, using the Webcloak configuration the intended End User-B is logged into; the CCA 1999 encrypts the intended End User-B's messages using the Encryption Markers 300-348 (see FIGS. 2-A, 2-B and 2-C for more information on the encryption process). The CCA 1999 sends the Encrypted Messages 1002 to intended End User-B. The CCA 1999 updates the last known location of all Encryption Markers 300-348 in the end user's Webcloak's recipe. In step 1543-A, End User-B's process continues at FIG. 15-A step 1526 - Substitute the name “End User-A” for the new reference, “End User-B”. In step 1543-B, the process for End User-A is continued to step 1545.

In step 1545, as long as End User-A is logged onto the CCA 1999; the CCA 1999 will continue to use the Webcloak End User-A used to logon to send any additional messages sent to End User-A.

In step 1546, question twenty . . . Does End User-A remain logged on to CCA 1999? In step 1551-1552 and with a “no” response, End User-A will either voluntarily logs off the CCA 1999 or is “Timed Out” using preset criteria within the CCA 1999. In either situation, the process ends.

In step 1547, If End User-A remains logged on to the CCA 1999 (a “YES” answer), than the CCA 1999 will continue to wait unless either the end user 1) send a message, 2) received a message, 3) intentionally logs off the system or 4) the end user is timed out of the system. Question twenty-one . . . Does End User-A send a message? This refers to the entire time period the End User-A continues to be logged into the CCA 1999. In step 1548, if the answer is “Yes”, the process continues with step 1532 in FIG. 15-B. A “no” response prompts the flow to step 1549.

In step 1549, question twenty-two . . . Does End-User-A receive a message? This refers to the entire timeframe the End User-A continues to be logged into the CCA 1999. If another user who is logged into the CCA 1999 sends a message to End User-A while End User-A is logged in, then End User-A will receive the message right away. In steps 1551-1552, if the answer is no, the End User-A either voluntarily logs off the CCA 1999 or is “Timed Out” using preset criteria within the CCA 1999. The process ends. In step 1550, if the answer is “Yes”, the process continues in FIG. 15-A, step 1524.

FIG. 17, depicts an embodiment of a system that includes a Self Activating Virus (SAV) 2525 which facilitates removal of the Webcloak and/or the contents of the computer memory under predetermined circumstances indicating a likelihood of a security breach, as further described below.

Method of creation of a computer's Webcloak via a Central Code Administrator

With reference to FIG. 17, the role of the Central Code Administrator 1999 (CCA 1999) is as follows:

1) The CCA 1999 contains multiple versions of all variables required for the creation and re-creation of all Webcloak configurations including former, current and future Webcloak configurations. The CCA 1999 contains all (former, current and future) data files which are accessed for the recreation and duplication (with the exception of marker 300-398 alignment which may/may not be identical)) of a Webcloak contained on a computer or detachable device.

2) The CCA 1999 creates a unique combination of all variables needed for the exclusive use by either one computer or one detachable device. The exact specification required to create a unique Webcloak combination is called a “recipe”. A “recipe” is used by one computer or detachable device. With the exception of all Marker 300-398 locations, the components of a Webcloak's unique “recipe” will not change with each encryption and decryption process. When a computer or detachable device is discarded, the “recipe” information is saved, but not transferred to a new computer or detachable device. The “recipe” should not be duplicated or recycled at a later time.

3) See FIG. 9 for a hypothetical example of a segment of Virtual Wheels 100-148 that might be contained within the CCA 1999. The exact combination of Virtual Wheels 100-148 used for each Webcloak is never duplicated for another Webcloak. Example: Within the set of all Virtual Wheels 100-148, there can be a multitude of unique random order of the Single Digits 160 combinations contained within the subset of Virtual Wheels 100-148 with said subset containing the same number of random Single Digits 160.

Since the exact combination of all Virtual Wheels 100-148 with a recipe is never duplicated, an unbreakable code is created for each computer.

4) The CCA 1999 keeps a file of all “recipe” combinations for all active, inactive and retired Webcloaks so as to not duplicate them.

5) The CCA 1999 identifies the computer or detachable device from which the end user is signing onto using the identification number sent with every logon attempt.

6) The Identification numbers identifies the exact “recipe” which identifies the computer/detachable device the end user is signing onto. The CCA 1999 has the ability to duplicate the Webcloak held within said computer or detachable device.

7) By pulling the exact components and configuring the said components to replicate the end user's Webcloak, the CCA 1999 is able to fulfill its responsibility to authenticate the identification of the end user.

8) The CCA 1999 is responsible for the deciphering of all incoming messages from authorized users.

9) The decrypted messages are held by the CCA 1999 and distributed to the intended end user once said end user logs on to the CCA 1999.

10) Until said intended end user signs onto the CCA 1999 from a computer or detachable device with a Webcloak, all messages are kept secure.

11) When the intended end user signs on to the CCA 1999, the CCA 1999 re-encrypt all messages for said intended end user to the exact Webcloak recipe utilized by the computer or detachable device the intended end user is signed onto. All messages are then sent to said intended end user.

12) The CCA 1999 is responsible for the creation and updating of a list of all Webcloaks with a Self Activating Virus 2525 (SAV 2525) within its system. The list contains the Webcloak Identification (ID) number and the ID number for the computer or detachable device the Webcloak is assigned to. The SAV 2525 will be deployed ONLY when a computer on said list has been identified as being lost or stolen. Only then will the Webcloak's ID number be placed on the list called Self Termination Virus Deployment List 925. See FIG. 17 for the CCA 1999 and the SAV Deployment Checklist 925.

13) The CCA 1999 is responsible for checking all Webcloak ID numbers against said SAV Deployment List 925.

14) The CCA 1999 is responsible for the deployment of the SAV 2525 when a Webcloak ID number is found on the SAV Deployment List 925.

The Central Code Administrator's 1999 virtual warehouse includes:

All Virtual Wheels

Within the “set” of all Virtual Wheels 100-148, subsets are created. Each subset is created by using the total number of Single Digits 160 within a Virtual Wheels 100-148 as the sort criteria for a single subset. Within said subset, 1) All Virtual Wheels 100-148 should contain (but not limited to) an equal number (ideally within one) of each Single Digit 160 (zero through nine (0-9)). Example of a subset: The subset with 10,000 Single Digits 160 should ideally contain (but not limited to) 1,000 of each digit zero through nine (0-9). All said subsets are identified by 1) the number of Single Digits 160 contained within each Virtual Wheel 100-148 of that subset and 2) a label identifying the exact configuration.

Turning to FIG. 9, an embodiment of an example of the subset identification of the Virtual Wheels 100-148 is shown. Within the subset containing all individual Virtual Wheels 100-148 with 10,000 digits would begin with the identification label 10,000. Virtual Wheels 100-148 with 10,004 total Single Digits 160 would be identified as 10,004.

From within each subset, a multitude (1,000+/−) of random order is created using all Single Digits 160 within the subset of consisting of the same number of total Single Digits 160 within each Virtual Wheels 100-148. Each string of Single Digits 160 never changes its order and each Single Digit 160 is assigned a Sequential Number 162.

Example: Create 2,000 +/−) random variations of the Single Digits 160 within each Virtual Wheels 100-148 within the subset of 10,000 total Single Digits 160; create 2,000 +/−) random order variations of Virtual Wheels 100-148 with 10,001 total Single Digits 160; create 2,000 +/−) random order variations of Virtual Wheels 100-148 with 10,002 total Single Digits 160 . . .

The Virtual Wheels 100-148 created for each subset are identified using two parts to every identification label. The first part is the name of the subset as identified above. The second part is the identification number given to all Virtual Wheels 100-148 within the same subset. Each of these Virtual Wheels 100-148 contains various orders of Single Digits 160 and each are provided with a unique identification number. An example might be 10,004 0289. Translation: a Virtual Wheel 100-148 with 10,004 Single Digits 160, configuration number 0289 from the subset of Virtual Wheels 100-148. Containing 10,004 Single Digits 160 in random order.

Encryption & Decryption Marker locations

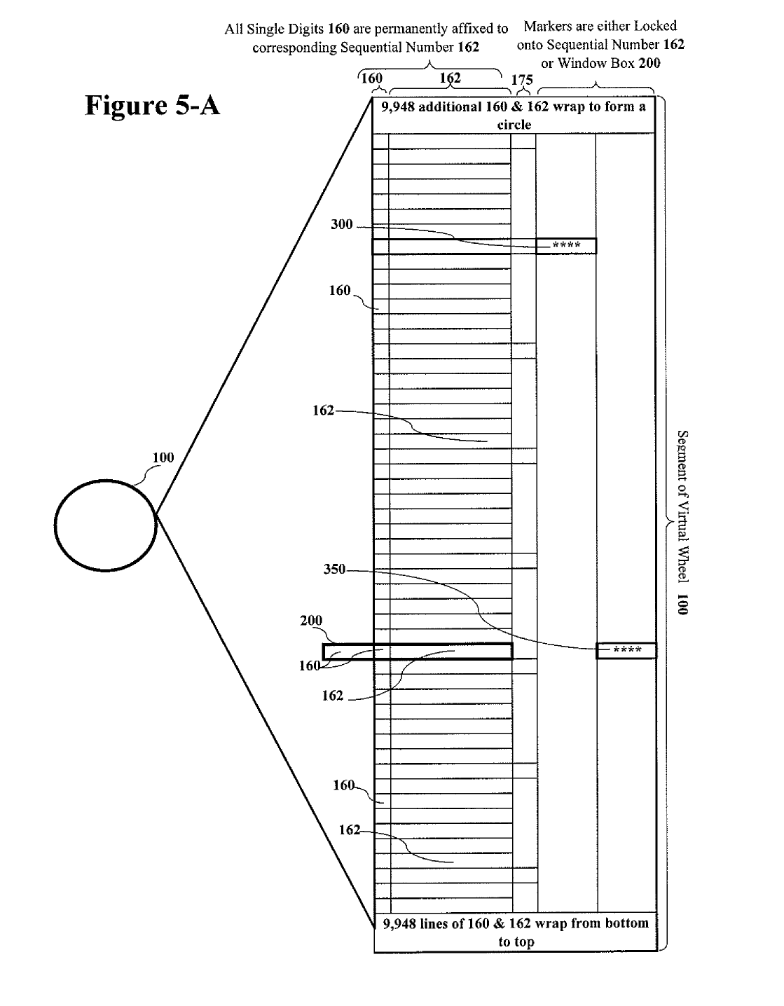

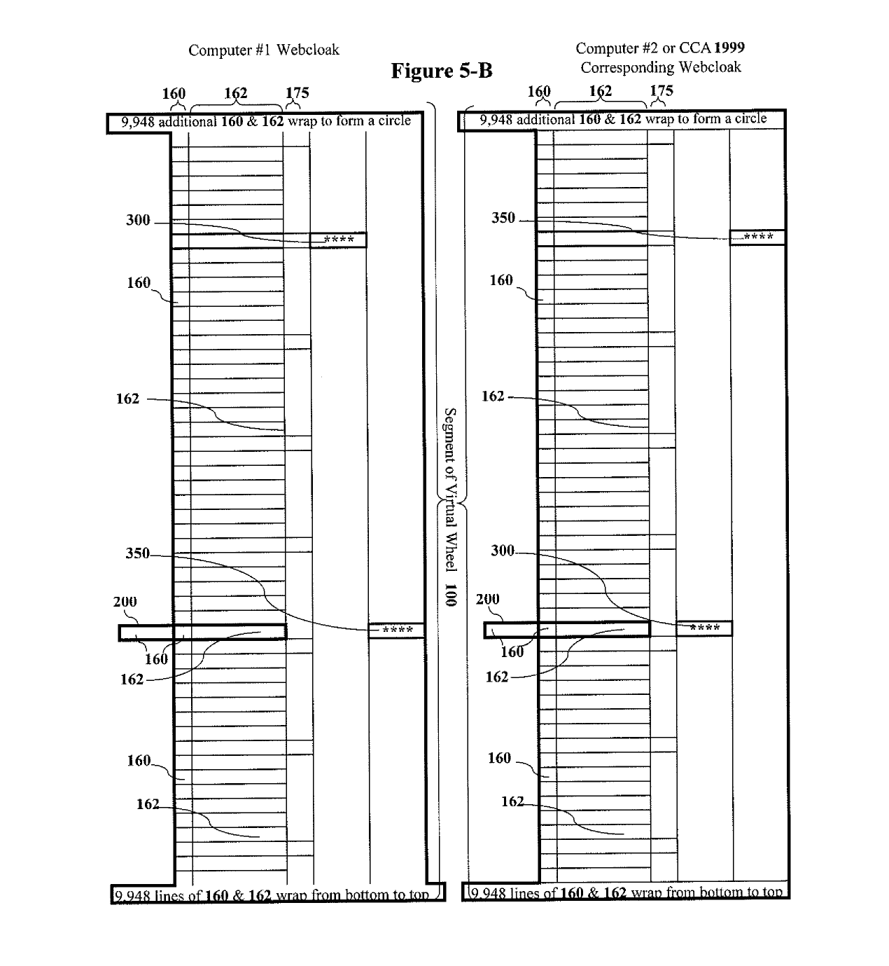

Turning to FIGS. 5-A and 5-B, an embodiment of Encryption Marker 300 and Decryption Marker 350 for Virtual Wheel 100 is shown. The exact location of the Window Boxes 200-248 upon their corresponding Virtual Wheels 100-148 at the time the encryption or decryption process was completed is marked with Markers 300-398 and is the only part of a Webcloak that changes with the encryption and decryption process.

Encryption Markers 300-348 and Decryption Markers 350-398 mark the location a Window Box 200-248 falls upon its corresponding Virtual Wheel 100-148. At any given time only one marker 300-398 per Virtual Wheel 100-148 is utilized as determined by either the encryption or decryption process.

Each of the Virtual Wheels 100-148 within a Webcloak has its own marker pair combination comprising of one Encryption Marker 300-348 and one Decryption Marker 350-398. Within the saved data of the CCA 1999, a set of possible Encryption Marker 300-348 and Decryption Marker 350-398 combinations are created within each Virtual Wheel's 100-148 subset.

When a Webcloak is initially created (as opposed to “recreated”), the initial location of the Encryption Marker 300-348 and Decryption Markers 300-398 is selected from a marker 300-398 pair combination within the same numeric subset as their corresponding Virtual Wheel 100-148 said subset. The number of Markers 300-398 pulled is equal to the number of Virtual Wheels 100-148.

### Example 1

From the Virtual Wheel 100-148 subset with 10,004 Single Digits 160, 20,036 marker pair combinations are created comprising of one Encryption Marker 300-348 and one Decryption Marker 350-398.

### Example 2

Within each Virtual Wheel 100-148 subset 10,024; 10,024 Encryption Markers 300-348 and 10,024 Decryption Markers 350-398 are combined for a total of 20,048 various marker pairs.

The marker locations are named as follows: All Encryption Markers 300-348 begin with the letter “E” denoting the number as an Encryption Marker 300-348 and is followed by the four-digit Sequential Number 162 that denotes the Single Digit 160 the Encryption Marker 300-348 fell upon.

All Decryption Markers 350-398 begin with a “D” denoting the number as a Decryption Marker 350-398 and is followed by the four-digit Sequential Number 162 that denotes the Single Digit 160 the Decryption Marker 350-398 fell upon. Preceding the marker pair with the identification of the Virtual Wheel 100-148 it represents.

Example: One set of markers belonging to the subset of 10,004 Single Digits 160 and is Virtual Wheel 100-148 Identification number from within said subset 0289 is written as follows with a VW to denote that it is a Virtual Wheel 100-148: VW 10,004 0289 E2525 D 0920

Example: From the Virtual Wheel 100-148 subset VW 10,004, a pair of markers 300-398 created specifically for the subset of 10,004 Single Digits 160 is pulled from the available 20, 036 marker pair combinations. The Encryption Marker 300-348 falls on the Single Digit 160 identified as 2520 and the Decryption Marker 350-398 falls on the Single Digit 160 identified as 0920 of the possible 10,004 placements available for each marker 300-398.

Example of a full identification number for the Encryption Marker 300-348 and Decryption Marker 350-398 as well as the Virtual Wheel 100-148 is as follows (VW denotes a Virtual Wheel 100-148 number): VW 10,004 0289, E2520 D0920

The placement of the markers 300-398 upon its corresponding Virtual Window 100-148 is only temporary as each encryption or decryption process changes each marker's location and subsequently the Sequential Number 162 representing said location. Thus, the identification number VW 10,004 0289, E2520 D0920 may change upon encryption or decryption to be VW 10,004 0289, E10, 002 D0920. The location of Encryption Markers 300-348 is saved every time an encryption is sent.

DS Assignment Number 440

Turning to FIGS. 16-A through 16-B, an embodiment of a hypothetical distribution of the value of each Window Box 200-248 is shown. DS Assignment Number 440 allocates the value of Window Box's 100-148 to various calculations:

The value of each of the 25 Window Boxes 200-248 is distributed to 3 subsets of numbers with each subset consisting of 10 values. In the interest of keeping a Webcloak as unique as possible, numerous variations of the Window Boxes 200-248 distribution are made and denoted by each Virtual Wheel's (VW) Sequential Order Label 1-25. FIG. 8 outlines a few examples of what the various distributions might look like. Example one is the same distribution as shown in an embodiment within FIG. 4. Example #2 is the hypothetical distributions of DS 8842.

Process: Create 3 said subset each consisting of 10 Window Box values 200-248 and label DS #1 410, DS #2 420 and Ds #3 430. First, identify and label all Virtual Wheels (VW) 100-148 by its sequential order within a Webcloak from 1-25. The name of the label is “VW Sequential Order Label 1-25” with said label also identifying the Window Box 200-248 of its corresponding Virtual Wheel 100-148

Each Window Box 200-248 is distributed to one of the 3 subsets. With only 25 Window Boxes 200-248 of a Webcloak consisting of only 25 Virtual Wheels 100-148, five of the Window Box 200-248 values will be used twice with no Window Box 200-248 used 3 times, no subset contains more than four (4) shared values, nor does any Window Box 200-248 go unused. The value of all 25 Window Boxes 200-248 are distributed among the 3 subsets and the distribution is saved and recorded with the Webcloak's recipe held within the records of the CCA 1999.

Create a multitude of variations (1,000 +/−) consisting of random distribution of the VW Sequential Order Label 1-25 into all three groups (DS #1 410, DS #2 420, and DS #3 430). The labels (1-25) will be assigned to one of the 25 Virtual Wheels 100-148 and its corresponding Window Box 200-248 found within a Webcloak. The labels will be used to allocate the value of the said Virtual Wheels' 100-148 corresponding Window Boxes 200-248 for use in the calculation of Driveshaft Subcomponent (DS) #1 410, DS #2 420 and DS #3 430.

An identification number called a Driveshaft Subcomponent (DS) Assignment Number 440 is given to each variation of the Window Box 200-248 assignments to specific number set used in the calculation of DS # 410, DS #2 420, DS #3, 430. The various distributions are saved within the CCA 1999 and distributed to new Webcloaks as they are created.

Example: DS 8842 (DS Assignment Number 440): DS #1 410, DS #2 420, DS #3 430. The values of Window Boxes 3, 10, 12, 18 and 25 are allocated to more than one DS subset.

Digital Curtain 700:

Create 1,000 +/−) variations of The Digital Curtain 700. As previously specified, one element (letter, number, space, symbol . . . ) is in: every column with only one element per column, and in every row with only one element per row. Assign an identification number to each variation of The Digital Curtain 700. The identification number is preceded with a “DC”. Examples: DC 0833, DC 0043, DC 0305.

Notably, Ground Zero 750 contained with the Digital Curtain 700 has a default start of the top most row and left most column.

Self Activation Virus 2525-Each Webcloak will note if the optional SAV 2525 has been installed. The information is kept so the Webcloak can erase the memory of a lost or stolen computer or detachable device upon a login attempt to the CCA 1999.

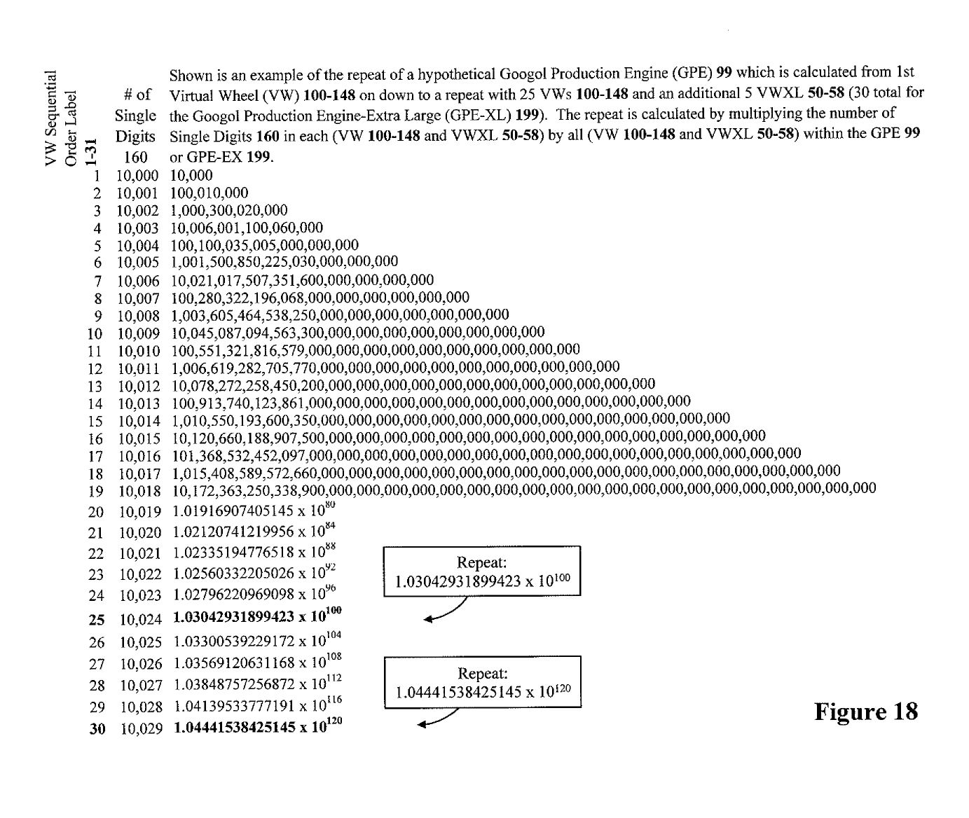

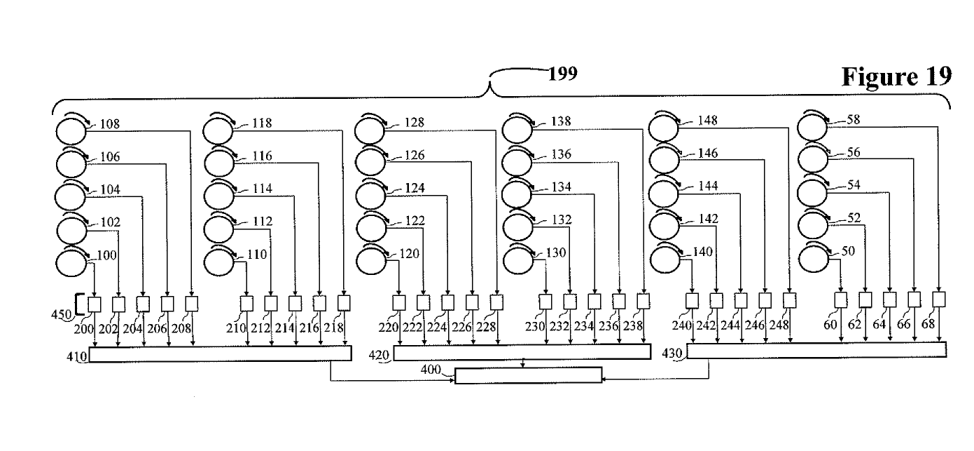

Turning to FIG. 19, an embodiment of the Googol Production Engine-Extra Large 199 is shown. The Googol Production Engine-Extra Large 199 contains the “original” 25 VW 100-148 as well as an additional 5 VW Extra Large 50-58 as shown. The repeat increases to 1.04441538425145×10¹²⁰ (see FIG. 18). The unbreakable encryption offered by the GPE 99 is everything a provably unbreakable encryption process should be. However, in the interest of setting apart individual use computers from larger applications such as military transmissions, credit card transactions or corporate transmissions, the Webcloak with the Googol Production Engine-Extra Large 1999 offers the ability to create a unique standard that sets itself apart from the other computer Webcloaks. The protection is similarly provable with the same process that accommodates the additional VW Extra Large 50-58 and its Window Boxes 60-68.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An electronic data encryption system comprising:
an encryption processor;
a computer readable memory operatively connected to the encryption processor, the computer readable memory receiving an input of a data element for encryption and having stored thereon a plurality of modules comprising computer executable instructions executed by the encryption processor, the modules comprising:
(a) a googol production engine comprising a plurality of virtual wheels, each virtual wheel comprising a queue of a plurality of random single digit numbers, the virtual wheel configured for selecting a single digit selected from the plurality of random single digit numbers in a continuous circular order such that as a last digit in the queue is selected a first digit is queued up for a subsequent selection, wherein each virtual wheel in the plurality of virtual wheels comprises at least a predetermined number of single digit numbers, each virtual wheel in the plurality of virtual wheels having a different amount of single digit numbers than the other virtual wheels;
(b) a digital curtain module comprising a symbol encryption table wherein each column and row intersection corresponds to a numerical coordinate, the numerical coordinate corresponding to each column and row intersection having a single entry comprising one of the received input data element and an inert ingredient, the inert ingredient comprising a predetermined filler encryption element;
(c) a decider module for selecting one of the input data element and the inert ingredient for encryption via the digital curtain, the decider module making said selection based on a sum of the single digits selected by each of the plurality of virtual wheels;
(d) a column selector module for advancing and selecting the column in the digital curtain module for encryption output, the column selector module identifying each digit of the numerical coordinate of the column in the digital curtain by computing a last digit of a sum of the digits selected by a respective subset of the virtual wheels, the encryption output comprising of a count of rows to the numerical coordinate of the column and row intersection corresponding to one of the input data element and the inert ingredient selected for encryption; and
a communications interface operatively connected to the computer readable memory and the encryption processor for transmitting the encryption output to a remote computing device.

2. The system of claim 1 wherein the single entry corresponding to the received input data element is selected from the group consisting of:
i. a letter;
ii. a number;
iii. a digital file;
iv. a symbol;
v. a character: and
vi. a pictogram.

3. The system of claim 1 wherein the googol production engine comprises at least twenty five (25) virtual wheels.

4. The system of claim 3 wherein each of the plurality of virtual wheels comprises at least ten thousand (10,000) single digit numbers.

5. The system of claim 4 wherein the amount of single digit numbers in each of the plurality of virtual wheels differs by at least one digit.

6. The system of claim 5 wherein a repeat period for the selections made by at least one of the decider module and the column selector module is at least a googol.

7. The system of claim 1 wherein the digital curtain module is configured to fill approximately fifty (50) percent of encryptions with the predetermined inert ingredient element.

8. The system of claim 1 wherein the decider module selects one of the input data element and the inert ingredient for encryption based on parity of the sum of the single digits selected by each of the plurality of virtual wheels.

9. The system of claim 1 wherein the remote computing device participates in an electronic commerce session with the communications interface.

10. The system of claim 1 wherein the remote computing device participates in an e-mail communication session with the communications interface.

11. A computer readable medium having stored thereon computer executable instructions for electronic data encryption, the instructions comprising:
receiving an input of a data element for encryption;
via a googol production engine module comprising a plurality of virtual wheels, selecting from each virtual wheel a single digit, the single digit in each virtual wheel selected among a plurality of random single digit numbers organized as a circular queue in each virtual wheel, wherein each virtual wheel in the plurality of virtual wheels comprises at least a predetermined number of single digit numbers, each virtual wheel in the plurality of virtual wheels having a different amount of single digit numbers than the other virtual wheels;
selecting, by a decider module, one of the input data element and an inert ingredient for encryption by a digital curtain module, the digital curtain module comprising a symbol encryption table wherein each column and row intersection corresponds to a numerical coordinate, the numerical coordinate corresponding to each column and row intersection having a single entry comprising one of the received input data element and the inert ingredient, the inert ingredient comprising a predetermined filler encryption element, wherein the decider module makes said selection of one of the input data element and the inert ingredient based on a sum of the single digits selected by each of the plurality of virtual wheels;
encrypting selected one of said input data element and the inert ingredient by determining, via a column selector module, a numerical coordinate of a column in the digital curtain module for encryption output, the column selector module identifying each digit of the numerical coordinate of the column in the digital curtain by computing a last digit of a sum of the digits selected by a respective subset of the virtual wheels, the encryption output comprising the numerical coordinate of the column and row intersection corresponding to one of the input data element and the inert ingredient selected for encryption.

12. The computer readable medium of claim 11 wherein the instructions further comprise transmitting the encryption output to a remote computing device.

13. The computer readable medium of claim 11 wherein the single entry corresponding to the received input data element is selected from the group consisting of:
i. a letter;
ii. a number;
iii. a symbol;
iv. a digital file;
v. a character: and
vi. a pictogram.

14. The computer readable medium of claim 11 wherein a repeat period for the selections made by at least one of the decider module and the column selector module is at least a googol (1×10¹⁰⁰).

15. The computer readable medium of claim 11 wherein the digital curtain module is configured to fill approximately fifty (50) percent of encryptions with the predetermined inert ingredient element.

16. The computer readable medium of claim 11 wherein the decider module selects one of the input data element and the inert ingredient for encryption based on parity of the sum of the single digits selected by each of the plurality of virtual wheels.

17. A method for electronic data encryption executed by an encryption processor of a computing device, wherein the encryption processor executes computer executable instructions stored in computer readable memory, the instructions comprising steps of:
receiving, at the computing device, an input comprising a data element for encryption;
via a googol production engine module comprising a plurality of virtual wheels, selecting from each virtual wheel a single digit, the single digit in each virtual wheel selected among a plurality of random single digit numbers organized as a circular queue in each virtual wheel;
selecting, by a decider module, one of the input data element and an inert ingredient for encryption by a digital curtain module, the inert ingredient comprising a predetermined filler encryption element, the digital curtain module comprising a symbol encryption table wherein each column and row intersection corresponds to a numerical coordinate, the numerical coordinate corresponding to each column and row intersection having a single entry comprising one of the received input data element and the inert ingredient;
encrypting the selected one of said input data element and the inert ingredient by determining, via a column selector module, a numerical coordinate of a column in the digital curtain module for encryption output, the encryption output comprising the numerical coordinate of the column and row intersection corresponding to one of the input data element and the inert ingredient selected for encryption, such that the encryption processor is capable of transmitting the encryption output to a remote computing device.

18. The method of claim 17 wherein each virtual wheel in the plurality of virtual wheels comprises at least a predetermined number of single digit numbers, each virtual wheel in the plurality of virtual wheels having a different amount of single digit numbers than the other virtual wheels.

19. The method of claim 17 wherein the decider module makes said selection of one of the input data element and the inert ingredient based on a sum of the single digits selected by each of the plurality of virtual wheels.

20. The method of claim 17 wherein the column selector module identifies each digit of the numerical coordinate of the column in the digital curtain by computing a last digit of a sum of the digits selected by a respective subset of the virtual wheels.

21. The system of claim 1 further comprising a ground zero module including a single box defined by an intersection of one column and one row which continually changes location with each encryption process to a location of each encryption so as to make a recently encrypted item a new location of ground zero having coordinates (000, 000).

22. The system of claim 1 wherein an actual length of the encryption is concealed by use of variable quantities of inert ingredients.

23. The system of claim 1 further comprising a plurality of encryption markers for marking the most recently used location of the virtual wheels which becomes a starting point for the next encryption.

24. The system of claim 1 further comprising a Central Code Administrator apparatus for facilitating encryption and decryption of end user messages by storing a state of the plurality of modules for the end user.
